(19) United States
(12) Patent Application Publication
(10) Pub. No.: US 2026/0346219 A1
(43) Pub. Date: Nov. 5, 2026

(54) ROCKING ASSEMBLY FOR MIXING AND COOLING A LIQUID

(71) Applicants: Life Technologies Holdings PTE Ltd, Singapore (SG); Life Technologies Corporation, Carlsbad, CA (US)

(72) Inventors: Kunjan Kamleshkumar DESAI, Foster City, CA (US); Jie Wen Ronson FONG, Singapore (SG); Walter James FRANDSEN, Vista, CA (US); Siu Wee HON, Singapore (SG); Wen-Li KAO, Singapore (SG); Namritha RAVINDER, San Diego, CA (US); Mang Khong WONG, Singapore (SG); Huei Steven YEO, Singapore (SG)

(21) Appl. No.: 19/486,277

(22) PCT Filed: May 31, 2024
(86) PCT No.: PCT/US2024/032089

§ 371 Date: Nov. 20, 2025

Related U.S. Application Data
(60) Provisional application No. 63/588,992, filed on Oct. 9, 2023.

(30) Foreign Application Priority Data
Jun. 3, 2023 (SG) SG10202301562W
Jun. 20, 2023 (SG) SG10202301759V

(51) Int. Cl. B01F 31/23; B01F 31/20; B01F 35/43; B01F 35/90; B01F 35/92; B01F 101/44

(52) U.S. Cl. CPC B01F 31/23; B01F 31/26; B01F 35/43; B01F 35/92; B01F 2035/98; B01F 2101/44

(57) ABSTRACT

A rocking assembly for mixing and cooling a liquid, such as a cell containing liquid (e.g., cell-based therapeutic product). A cell processing system for fill and finish processes in the manufacture of cell-based therapeutics including the rocking assembly and a liquid dispensing system. A method for processing a liquid for fill and finish workflow applications.

### CROSS REFERENCE TO RELATED APPLICATION(S)

This application is a U.S. 371 National Phase of International Application No. PCT/US2024/032089, filed May 31, 2024 which claims the benefit of priority to SG Patent Application No. 10202301562W, filed Jun. 3, 2023; SG Patent Application No. 10202301759V, filed Jun. 20, 2023; and U.S. Provisional Patent Application No. 63/588,992, filed Oct. 9, 2023, the disclosures of which are considered part of, and are herein incorporated by reference in the disclosure of this application.

### FIELD

The present invention relates generally to devices for processing cells, and more particularly to a rocking assembly for mixing and cooling a cell containing liquid, a system including the assembly, as well as methods of use thereof.

### BACKGROUND INFORMATION

Cell therapies are becoming established therapeutic products that require genetic manipulation, expansion and formulation of live, human derived cells. Formulation, fill and finish is the final fluidic process conducted on cell based therapeutic products. Cells have a limited life outside the body, and often it is impractical to apply cell therapy to a patient immediately. It is therefore typically necessary to store cell based therapeutic products, for a least a short period of time. These products are commonly stored by cryogenic freezing. A “cryoprotectant” media, such as DMSO, is commonly mixed with the cell product as part of the formulation process. The cells can become unstable and have a short time to remain viable in cryoprotectant media until they are frozen. There is a limited time window from exposure to the media before freezing. Missing this window of stability for the cryoprotectant results in increased cell death and decreased clinical efficacy.

Provided that cells, as well as other biomolecules have a relatively short time period within which they must be used or safely frozen to remain viable, production of a cell-based therapeutics requires devices that are able to formulate and cool cells in the final steps of production.

Additional considerations must also be taken to ensure that cell therapies are produced in a sterile environment that reduces the risk of contamination throughout the production workflow. This includes both the design of the workflow, as well as the design of instrument components in the workflow to mitigate risks of contamination. Regarding component design, it is advantageous to reduce use of instruments that include components that can unintentionally spread contamination, such as the use of instruments in specific steps of the production workflow that utilize components with non-contained forced air flow.

Conventional fill and finish devices and methods suffer from a number of shortcomings, specifically with regard to mixing of final formulations and cooling cell-based therapeutic formulations before use in a patient, as well as fully mitigating contamination risks. As such, there is an ongoing need and desire for improved devices and methods which can be applied in the fill and finish process to produce cellular therapeutics.

### SUMMARY

Various aspects of the present disclosure extend at least to assemblies, systems, and/or methods used to mix and cool cell-based therapeutics in the fill and finish process of manufacturing.

In one aspect, the present disclosure provides an assembly for mixing and cooling a liquid, such as a reagent or cell containing liquid (e.g., cell-based therapeutic product). In various embodiments, the assembly includes:
a base unit having a mount;
a platform;
a cooler module operably connected to the platform and the mount, the cooler module configured to cool the platform; and
an actuator in operable connection with the cooler module, the actuator being configured to move the platform in a rocking motion relative to the base unit to cool, or mix and cool a liquid held within a container disposed on and/or secured to the platform.

In another aspect, the present disclosure provides a cell processing system used for fill and finish processes in the manufacture of cell-based therapeutics. In embodiments, the cell processing system includes a rocking assembly of the disclosure and a liquid dispensing system. In some embodiments, the rocking assembly and the liquid dispensing system are in electronic communication so that operations of the separate assemblies can be aligned to decrease degradation and/or loss of temperature sensitive components of the liquid, for example cells of a cell-therapy product, throughout fill and finish processing.

In still another aspect, the present disclosure provides a method of processing a liquid, such as a cell containing liquid. In some embodiments, the method includes mixing and cooling a container holding a liquid with the rocking assembly or cell processing system of the disclosure. In some embodiments, the method includes mixing, cooling, formulating, and/or dispensing of a liquid disposed in a container functionally engaged with the rocking assembly or cell processing system of the disclosure.

### BRIEF DESCRIPTION OF THE DRAWINGS

For a fuller understanding of the nature and advantages of the present invention, reference should be made to the following detailed description taken in connection with the accompanying drawings. It is appreciated that these drawings depict only typical embodiments of the invention and are therefore not to be considered limiting of its scope. The disclosure will be described and explained with additional specificity and detail through the use of the accompanying drawings.

FIG. 1 is a side view of a rocking assembly illustrating rocking motion of the platform relative to the base unit in embodiments of the disclosure.

FIG. 2 is a side view of a rocking assembly illustrating rocking motion of the platform relative to the base unit in embodiments of the disclosure.

FIG. 3 is a side view of a rocking assembly illustrating rocking motion of the platform relative to the base unit in embodiments of the disclosure.

FIG. 4 is a top view of the rocking assembly shown in FIGS. 1-3. Line A-A′ is a transverse axis of the platform about which the platform performs rocking motion.

FIG. 5 is an elevated perspective view of a rocking assembly in embodiments of the disclosure.

FIG. 6 is an elevated perspective view of the rocking assembly of FIG. 5 with the platform tilted opposingly to that depicted in FIG. 5.

FIG. 7 is a front view of the rocking assembly of FIG. 5 with the cover assembly closed.

FIG. 8 is an elevated perspective view of the rocking assembly of FIG. 5 with the cover assembly open.

FIG. 9 is a front view of the rocking assembly of FIG. 5 with the cover assembly open.

FIG. 10 is a left plan view showing of the rocking assembly of FIG. 5 showing internal aspects of the assembly.

FIG. 11 is an elevated perspective view of the cooler module engaged with the platform.

FIG. 12 is an expanded, elevated perspective view of the cooler module and cover assembly of the rocking assembly of FIG. 5.

FIG. 13 is a lowered, perspective view of the cooler module and cover assembly of the rocking assembly of FIG. 5.

FIG. 14 is a top plan view of the cooler module of the rocking assembly of FIG. 5 showing internal components of the cooler module.

FIG. 15 is a cross sectional view along dotted line A-A′ of the cooler module shown in FIG. 14.

FIG. 16 is a cross sectional view along the major length of the cooler module shown in FIG. 14.

FIG. 17 is a cross sectional view of the cooler module and cover assembly in the closed position of the rocking device shown in FIG. 5.

FIG. 18 is a schematic diagram illustrating electronic connectivity of components of the rocking assembly shown in FIG. 5.

FIG. 19 is schematic diagram illustrating a cover assembly in the open position in embodiments of the disclosure.

FIG. 20 is schematic diagram illustrating a container for use with the rocking assembly in embodiments of the disclosure.

FIG. 21 is an elevated perspective view of a cavity of the rocking assembly having a container with fluid conduits disposed therein in embodiments of the disclosure.

FIG. 22 is an elevated perspective view of an empty container received by an open cover assembly in embodiments of the disclosure.

FIG. 23 is an elevated perspective view of a filled container disposed in an open cover assembly in embodiments of the disclosure.

FIG. 24 is an exploded view showing fluid conduits of a container disposed on the rocking assembly in embodiments of the disclosure.

FIG. 25 is partial cross sectional view of a cover assembly showing a container secured by securing member in the cover assembly in embodiments of the disclosure.

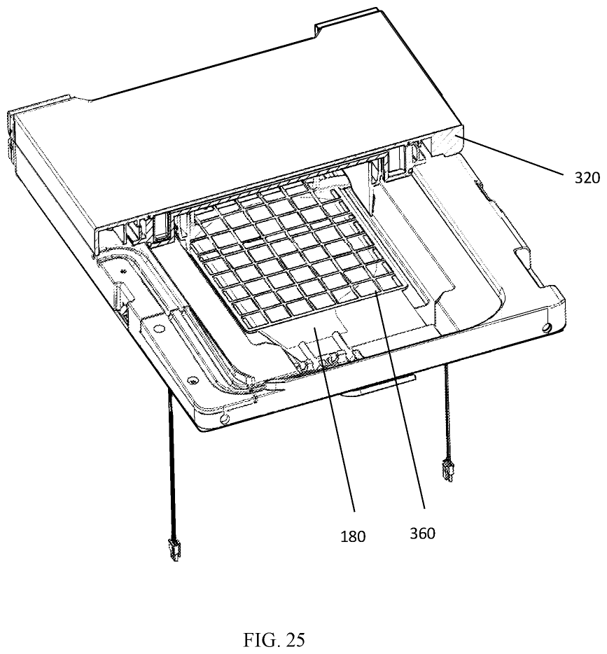

FIG. 26 is an elevated perspective view of a cavity within a cover assembly in which a securing member is illustrated in embodiments of the disclosure.

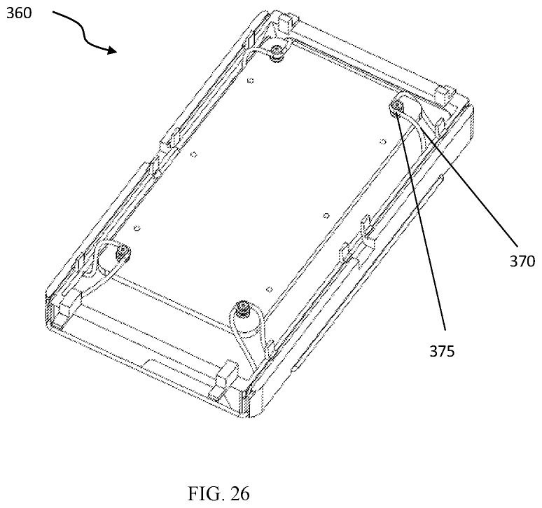

FIG. 27 is a diagram showing a securing member having posts and tensioning thread engaged with a planar substrate configured to engage and secure a container on a platform of a rocking assembly in embodiments of the disclosure.

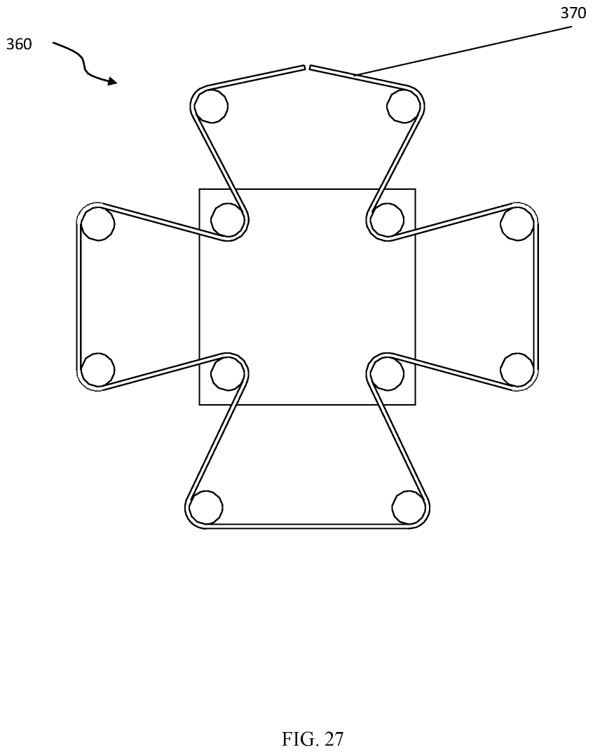

FIG. 28 is a magnified view of a securing member in embodiments of the disclosure.

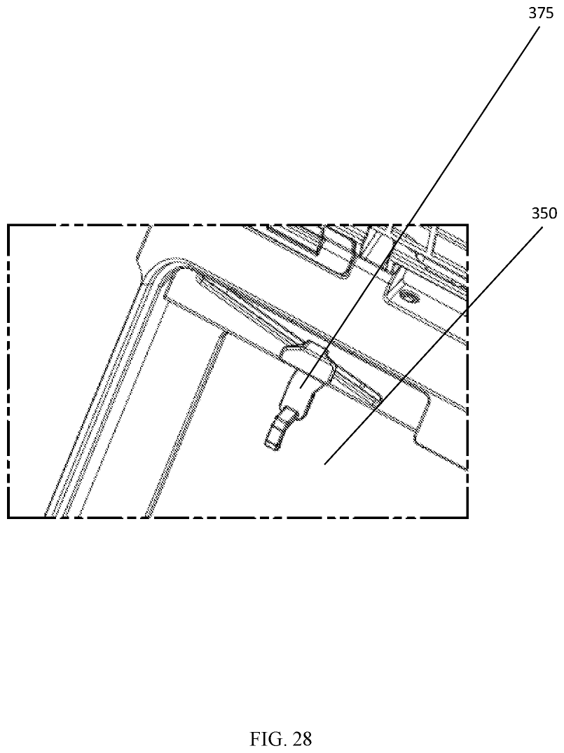

FIG. 29 is a perspective view of an actuator and mount of the rocking assembly of the disclosure illustrating generation of rocking movement in embodiments of the disclosure.

FIG. 30 is a perspective view of an actuator and mount of the rocking assembly of the disclosure illustrating generation of rocking movement in embodiments of the disclosure.

FIG. 31 is a perspective view of an actuator and mount of the rocking assembly of the disclosure illustrating generation of rocking movement in embodiments of the disclosure.

FIG. 32 is a perspective view of an actuator and mount of the rocking assembly of the disclosure illustrating generation of rocking movement in embodiments of the disclosure.

FIG. 33 is a side view of a rocking assembly having a touch screen in a first position in which the touch screen is partially obstructed by the platform during operation of the rocking assembly in embodiments of the disclosure.

FIG. 34 is an elevated perspective view of a rocking assembly having a touch screen in a first position in which the touch screen is partially obstructed by the platform during operation of the rocking assembly in embodiments of the disclosure.

FIG. 35 is a side view of a rocking assembly having a touch screen in a second extended position in which the touch screen is unobstructed by the platform during operation of the rocking assembly in embodiments of the disclosure.

FIG. 36 is an elevated perspective view of a rocking assembly having a touch screen in a second extended position in which the touch screen is unobstructed by the platform during operation of the rocking assembly in embodiments of the disclosure.

FIG. 37 is a schematic diagram of a cell processing system in which the rocking assembly and the liquid dispensing system are not fluidically connected in embodiments of the disclosure.

FIG. 38 is a schematic diagram of the cell processing system of FIG. 37 in which a container disposed on the rocking assembly is fluidly connected with containers of the liquid dispensing system for introducing liquid into the container of the rocking assembly and withdrawing liquid from the container of the rocking assembly for dispensing into one or more receiving vessels of the liquid dispensing system in embodiments of the disclosure.

### DETAILED DESCRIPTION

Implementations of the present disclosure extend at least to pipettes used for electroporation, as well as electroporation systems and/or components thereof which utilize such pipettes. The disclosed aspects and embodiments may be implemented to address various shortcomings associated with at least some conventional pipettes and electroporation systems and/or techniques. The following discussion outlines some example improvements and/or practical applications that may be provided by the disclosed embodiments. It will be appreciated, however, that the following are examples only and that the embodiments described herein are in no way limited to the example improvements discussed herein.

Before describing various embodiments of the present disclosure in detail, it is to be understood that this disclosure is not limited to the parameters of the particularly exemplified systems, methods, assemblies, products, processes, consumables, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments and is not necessarily intended to limit the scope of the claimed invention.

Furthermore, it is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

The term “comprising” which is synonymous with “including,” “containing,” “having” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, reference to a “port” includes one, two, or more ports.

As used in the specification and appended claims, directional terms, such as “top,” “bottom,” “left,” “right,” “up,” “down,” “upper,” “lower,” “inner,” “outer,” “internal,” “external,” “interior,” “exterior,” “proximal,” “distal” and the like are used herein solely to indicate relative directions and are not otherwise intended to limit the scope of the disclosure or claims.

Where possible, like numbering of elements have been used in various figures. Furthermore, alternative configurations of a particular element may each include separate letters appended to the element number. Accordingly, an appended letter can be used to designate an alternative design, structure, function, implementation, and/or embodiment of an element or feature without an appended letter. For instance, an element “80” may be embodied in an alternative configuration and designated “80a.” Similarly, multiple instances of an element and or sub-elements of a parent element may each include separate letters appended to the element number. In each case, the element label may be used without an appended letter to generally refer to all instances of the element or any one of the alternative elements. Element labels including an appended letter can be used to refer to a specific instance of the element or to distinguish or draw attention to multiple uses of the element.

Various aspects of the present assemblies, systems, and methods may be illustrated with reference to one or more exemplary embodiments. As used herein, the term “embodiment” means “serving as an example, instance, or illustration,” and should not necessarily be construed as preferred or advantageous over other embodiments disclosed herein.

Various aspects of the present devices and systems may be illustrated by describing components that are coupled, attached, and/or joined together. As used herein, the terms “coupled”, “operably coupled”, “functionally coupled”, “engaged”, “functionally engaged”, operably engaged”, “attached”, “connected” and/or “joined” are used to indicate either a direct connection between two components or, where appropriate, an indirect connection to one another through intervening or intermediate components. In contrast, when a component is referred to as being “directly coupled”, “directly engaged”, “directly attached”, “directly connected” and/or “directly joined” to another component, there are no intervening elements present.

Unless defined otherwise, all technical and scientific terms used herein have the same meaning as commonly understood by one of ordinary skill in the art to which the present disclosure pertains. Although a number of methods and materials similar or equivalent to those described herein can be used in the practice of the present disclosure, the preferred materials and methods are described herein.

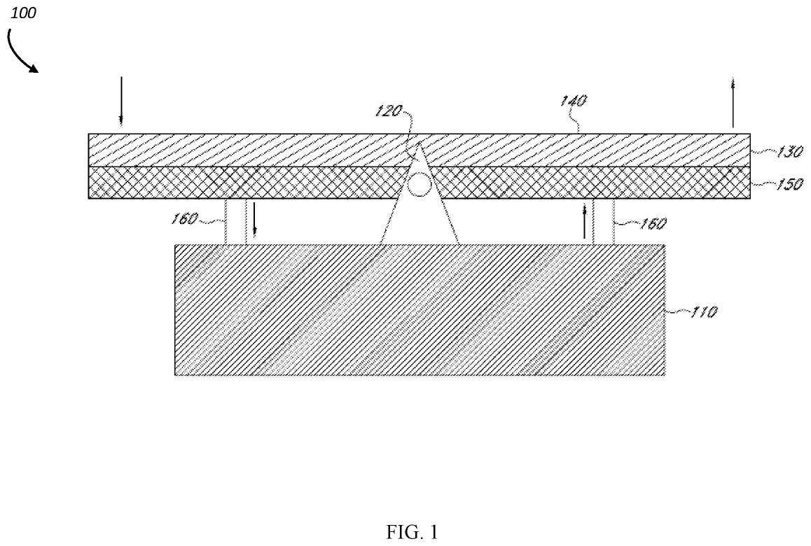

FIG. 1 illustrates various components of a rocking assembly 100 that may be used to implement one or more disclosed embodiments. As illustrated in FIG. 1, in some embodiments the rocking assembly 100 includes a base unit 110 operably coupled to a mount 120. As also shown, a platform 130 is pivotably secured to the mount 120 via a cooler module 150 such that the platform 130 is pivotally movable with respect to the base unit 110, for example, to move in a rocking motion to mix liquid within a container that is placed on a top surface 140 of the platform 130.

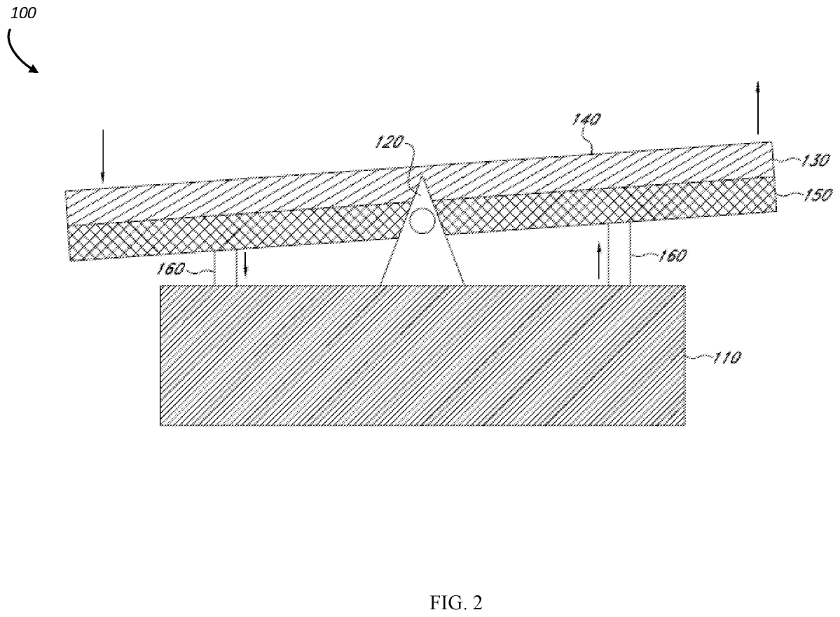

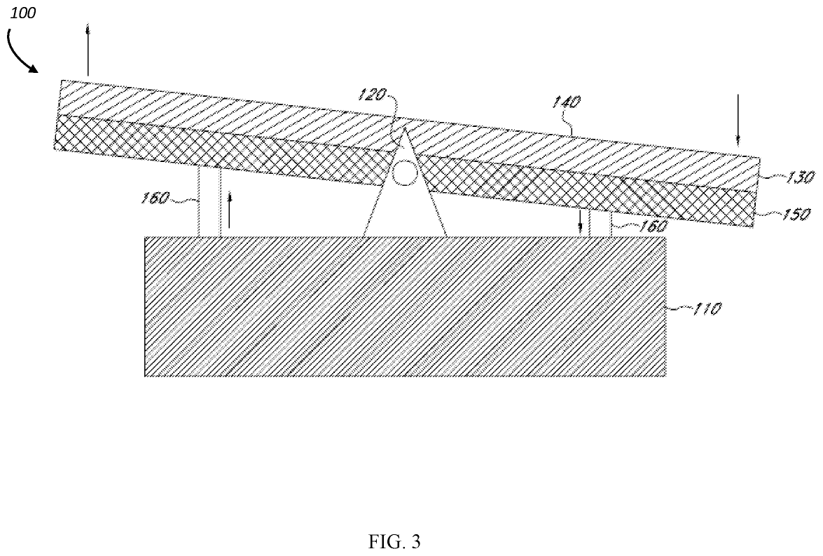

A cooler module 150 is operably connected to the platform 130 and the mount 120 and functions to cool (e.g., lower the temperature) the platform 130 so that the temperature of liquid in the container placed on the top surface 140 is lowered. The rocking assembly 100 also includes at least one actuator 160 in operable connection with the platform 130 which, when actuated, causes the platform 130 to perform a rocking motion relative to the base unit 110 to mix the liquid of the container when the actuator 160 is actuated as illustrated in FIGS. 1-4 and discussed in further detail herein.

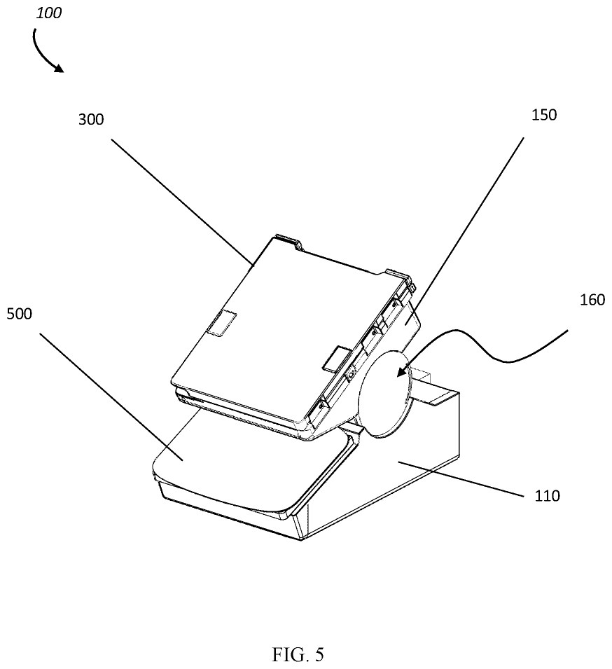

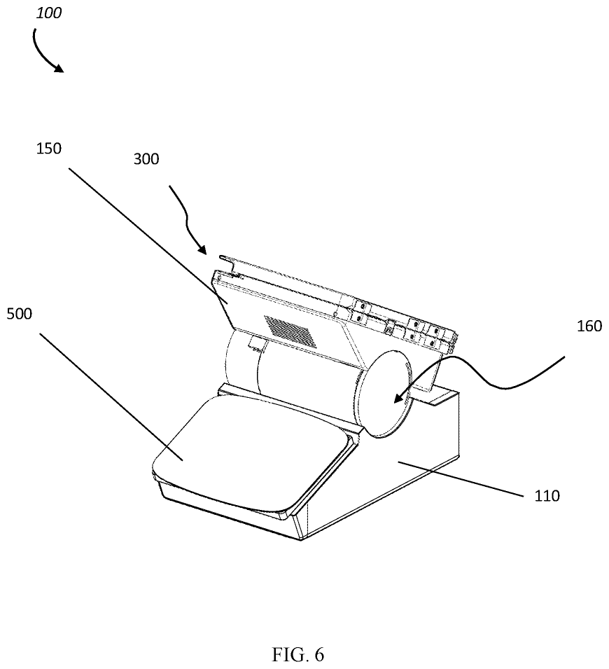

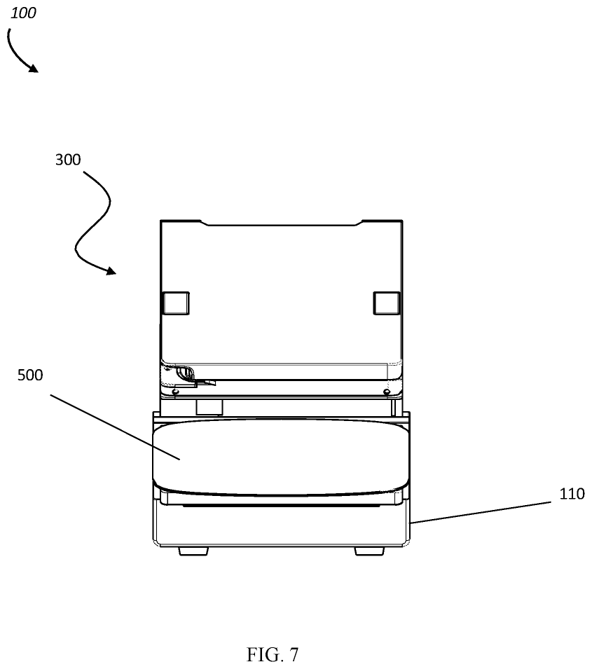

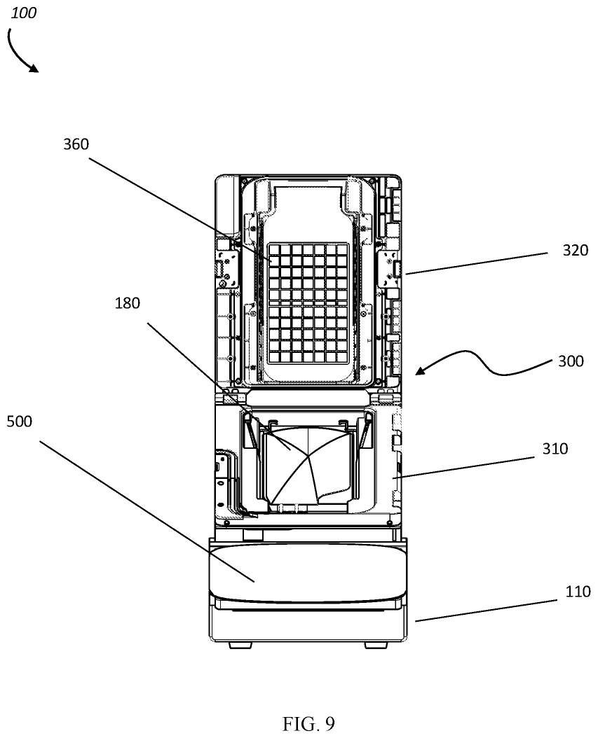

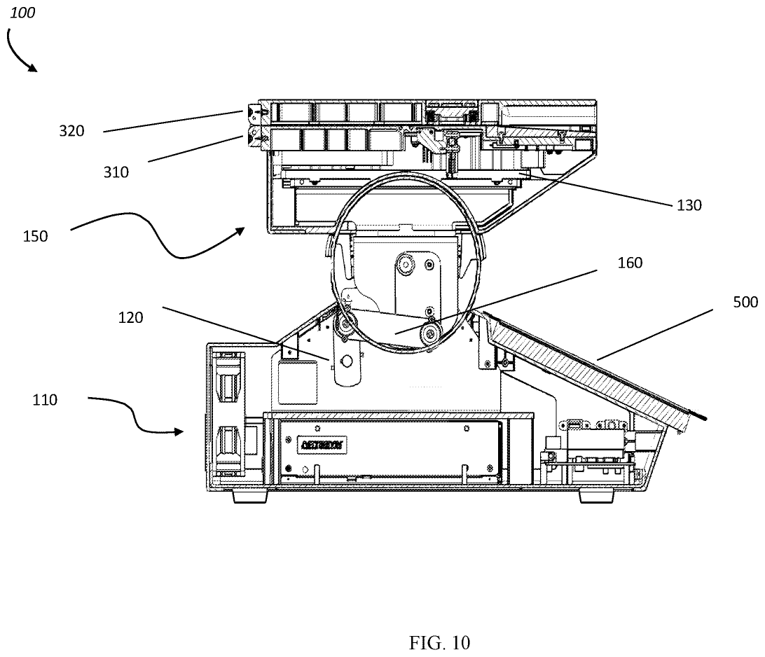

FIGS. 5-10 illustrate an embodiment of the rocking assembly 100 including a base unit 110 coupled to a mount 120. As also shown, a platform 130 is secured to the mount 120 via a cooler module 150 and configured such that the platform 130 is movable with respect to the base unit 110, for example, to move in a rocking motion to mix liquid within a container that is placed on a top surface 140 of the platform 130. The cooler module 150 is operably connected to the platform 130 and functions to cool (e.g., lower the temperature) the platform so that the temperature of liquid in the container placed on the top surface 140 is lowered. The rocking assembly 100 also includes at least one actuator 160 in operable connection with the platform 130 which, when actuated, causes the platform 130 to perform a rocking motion relative to the base unit 110 to mix the liquid of the container.

In various embodiments, the cooler module 150 includes functionality to uniformly cool the platform 130 and maintain the temperature of the platform at a temperature of less than or equal to about 10, 9, 8, 7, 6, 5 or 4 °C.

In embodiments, the rocking assembly 100 is designed to minimize, or otherwise prevent the risk of contamination. For example, in embodiments, the assembly does not include any components having fans which can be an unintended vector for contamination spread. In some embodiments, the platform 130 is cooled by a cooler module 150 that mitigates spread of contamination by being devoid of components that exhaust air to facilitate cooling and/or heating of the platform. In some embodiments, the cooler module 150 includes a thermo electric cooler (i.e., Peltier cooler) or other type of thermoelectric heat pump which transfers heat between different portions of the cooler module to cool the platform 130, and in some embodiments, does not require use of forced air to facilitate heat transfer throughout the different portions to achieve cooling.

In various embodiments, the cooler module is operable to cool the top surface of the platform 130 to a temperature of less than or equal to about 10, 9, 8, 7, 6, 5 or 4 °C. In some embodiments, the cooler module 150 is operable to cool the top surface 140 of the platform 130 sufficient to cool a liquid in a container, such as a flexible bag, disposed on the top surface to less than, or equal to about 10, 9, 8, 7, 6, 5 or 4 °C. In some embodiments, the cooler module 150 is operable to maintain the top surface 140 of the platform 130, or the liquid disposed on the platform, at a temperature of less than or equal to about 10, 9, 8, 7, 6, 5 or 4 °C.

In various embodiments, in operation, the cooler module 150 is operable to cool and/or maintain the entire top surface 140 such that the top surface has a uniform temperature across substantially the entire surface. In some embodiments, the temperature across the entire top surface various by less than about 5, 4, 3, 2, 1, 0.9, 0.8, 0.7, 0.6, 0.5, 0.4, 0.3, 0.2, 0.1, 0.05 or 0.01 °C.

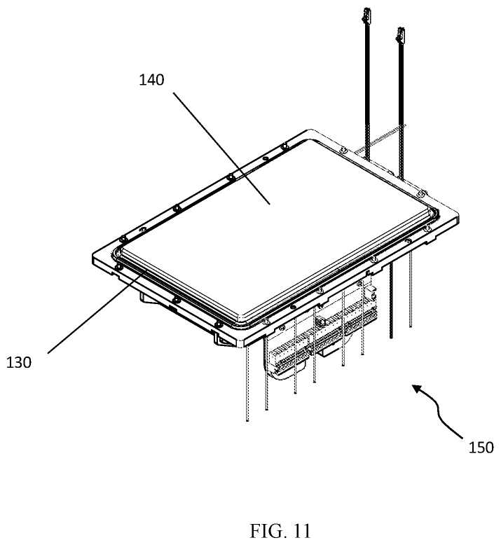

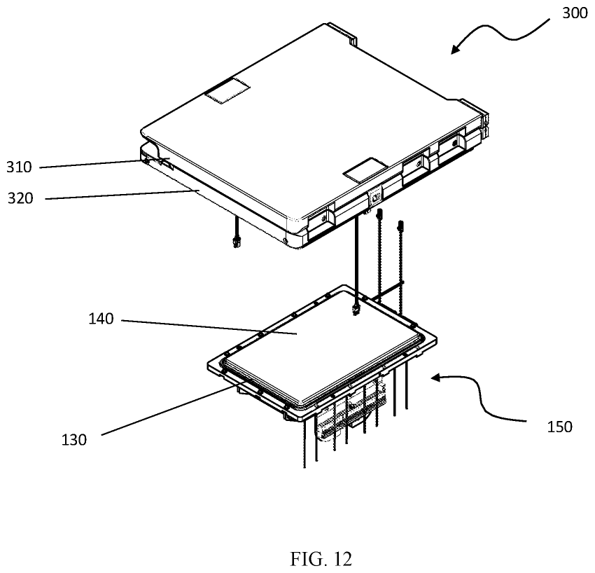

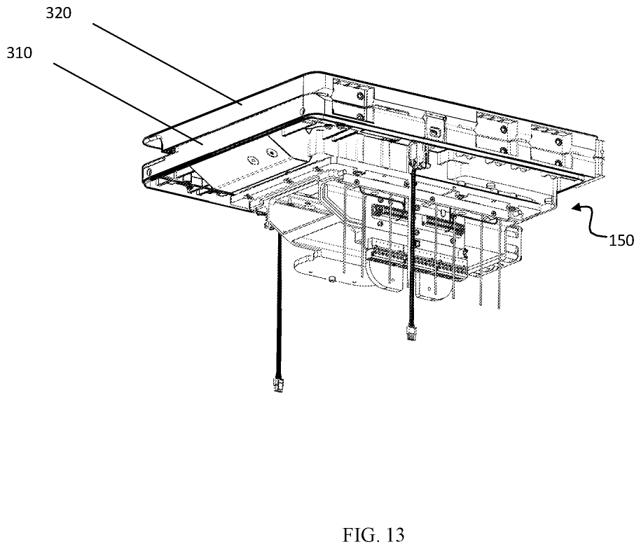

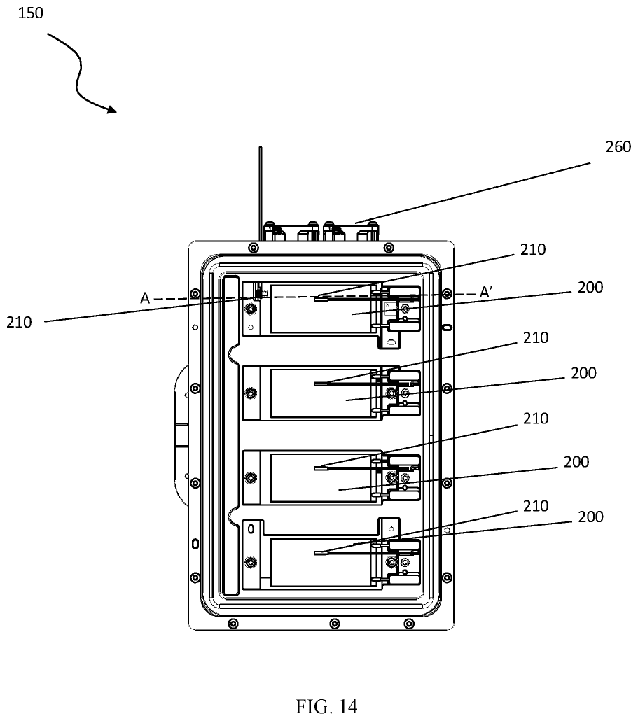

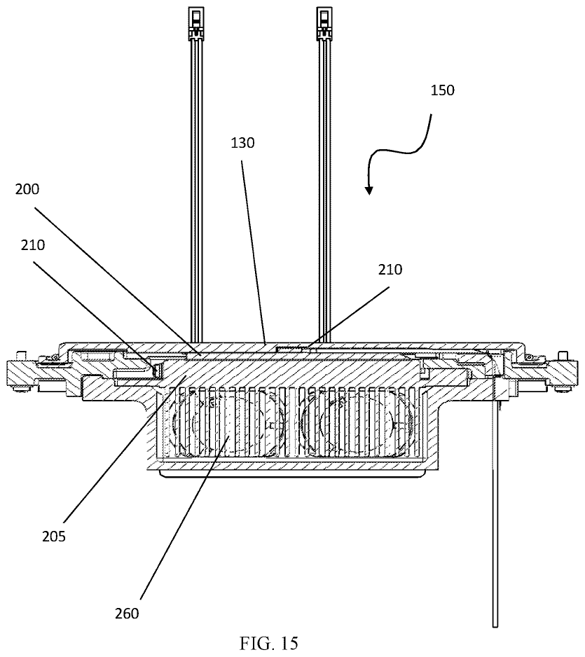

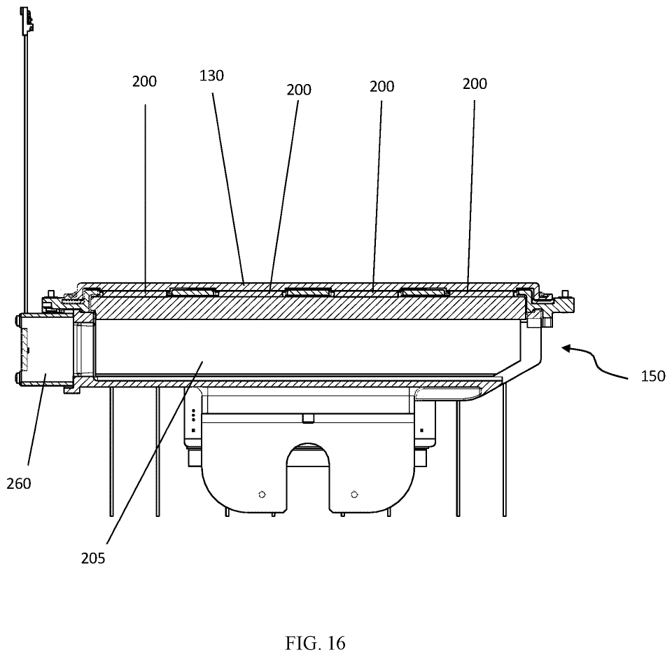

FIGS. 11-18 depict an illustrative example of the cooler module 150 coupled to the platform 130 for use in the rocking assembly 100 of the disclosure. FIG. 14 is a top view of the cooler module 150 showing the arrangement of internal components of the module while FIGS. 15 and 16 are cross-sectional views of the cooler module 150 depicted in FIG. 14 showing the cooler module 150 coupled to the platform 130. As shown FIG. 14, to achieve cooling of the platform 130, the cooler module 150 includes one or more thermo electric coolers 200 operably engaged with the platform 130. FIG. 14 shows 4 thermo electric coolers 200 arranged in a line pattern with equal spacing between them to achieve a uniform temperature spread on the platform 130 via Peltier cooling. It will be appreciated that while the embodiment shown in FIG. 14, utilizes 4 thermo electric coolers, the cooler module may utilize 1, 2, 3, 4, 5, 6, 7, 8, 9, 10 or thermo electric coolers 200 to achieve uniform cooling of the platform 130. In embodiments, the cooler module 150 also includes one or more temperature sensors 210, such as resistance temperature detectors or thermistors, to monitor the temperature of the platform 130.

As illustrated in FIG. 14, the cooling module may include one or more temperature sensors 210. In some embodiments, the cooler module includes 4 temperature sensors 210 in functional engagement with the platform 130 as shown in FIG. 14. The temperature sensors 210 may be arranged near the center of a given thermo electric cooler 200 to reduce the temperature delta reading between the thermo electric cooler 200 and the platform 130. In some embodiments, the cooler module 150 includes 2 additional temperature sensors 210, such as thermistors, mounted on a heatsink 205 to monitor the heatsink for temperature spikes. It will be appreciated that while the embodiment shown in FIG. 14 utilizes at least 5 temperature sensors 210, in various embodiments, the cooler module 150 may utilize any number of temperature sensors 210 including 1, 2, 3, 4, 5, 6, 7, 8, 9, 10, 11, 12, 13, 14, 15, 16, 17, 18, 20, 30, 40, 50 or more temperature sensors to achieve uniform cooling of the platform 130.

With reference to FIGS. 15 and 16, the cold side of the thermo electric coolers 200 may be in contact with the platform 130 and the hot side of the thermo electric coolers 200 may be in contact with the heatsink 205. As discussed herein, the heatsink 205 is configured to remove and/or mitigate the heat load from the thermo electric coolers 200 to prevent them from overheating. In embodiments, a temperature sensor 210 may be mounted on, or in functional engagement with the heatsink 205 and operable to monitor any temperature spike of the heatsink 205. Additionally, or alternatively, a temperature sensor 210 may be functionally engaged with the platform 130 to detect and feedback to a control module the temperature of the platform 130.

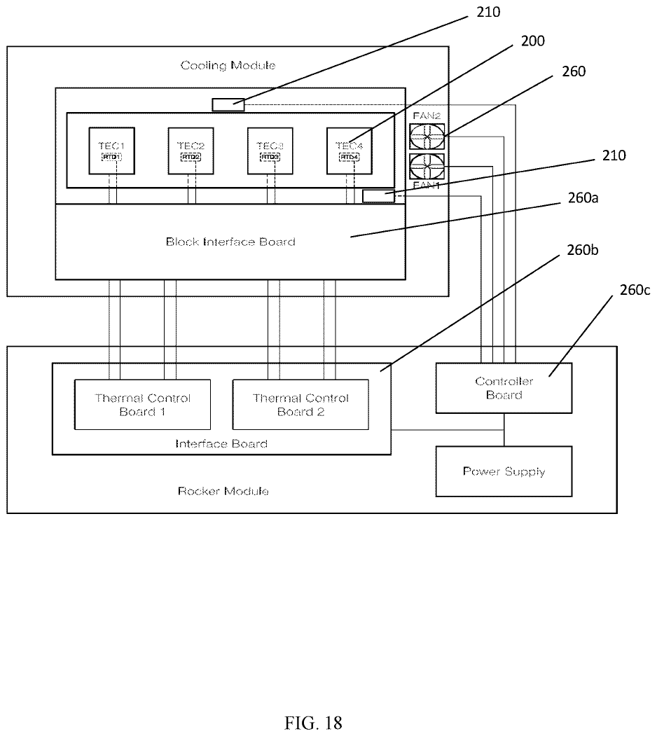

FIG. 18 provides a schematic diagram showing electrical connectivity of the components of the cooler module 150 for providing temperature monitoring and feedback for operation control of the cooler module 150 via one or more computer modules 250. Thermo electric coolers 200 and one or more temperature sensors 210 may be electrically connected to a first computer module 250a in the cooling module 150. The first computer module 250a may be in electrical connection with a second computer module 250b providing functionality for temperature control of the thermo electric coolers 200 and provide temperature feedback monitoring via a temperature sensor 210 (e.g., resistance temperature detector) functionally engaged with the platform 130. In embodiments, the second computer module 250b may be in electrical connection with a third computer module 250c which may be operable to continually monitor the temperature of the heatsink 205 through one or more temperature sensors 210 (e.g., thermistors) in functional engagement with the heatsink 205 and provide the required operational control to one or more fans 260 for cooling of the heatsink.

In various embodiments, the cooler module includes temperature data logging functionality for recording the actual temperature of the cooling surface near the sample container.

In various embodiments, the cooler module includes moisture sensors to detect condensation or frost accumulation and may include defrost cycles when cells are not present.

In various embodiments, the rocking assembly includes a dehumidifier to reduce condensation.

In various embodiments, the rocking assembly 100 includes a cover assembly 300. For example, with reference to FIGS. 5-10, the rocking assembly 100 may include a cover assembly 300 that is reversibly disposed over the platform 130. In embodiments, the cover assembly 300 may be hingably attached to the platform 130 and/or the cooler module 150. As illustrated in the Figures, the cover assembly 300 includes a lower cover member 310 and an upper cover member 320 that are hingably secured to one another with the lower cover member being connected to the platform 130 and/or the cooler module 150. In this manner, the upper cover member 320 can be opened by moving the upper cover member 320 about one or more hinges connecting the upper and lower cover members to each other such that a container can be placed upon the platform 130. Once the container is placed on the platform 130, the upper cover member 320 is closed onto the lower cover member 310 and the container may be rocked and/or chilled optionally following a workflow protocol.

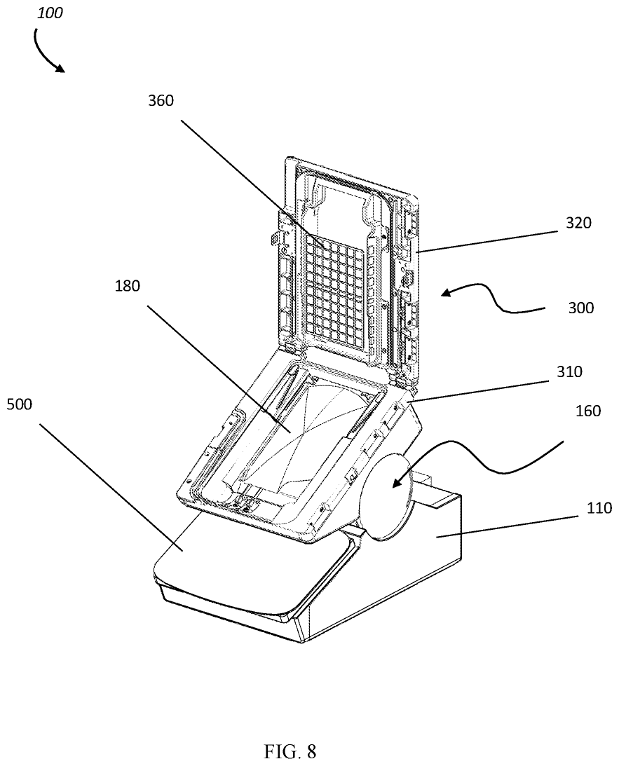

While the rocking assembly 100 depicted in FIGS. 8-13, illustrates a cover assembly 300 having an upper member 320 and a lower member 310 which are hingably connected, it will be appreciated that the cover assembly may be of a single unitary structure (e.g., one unitary member) that is optionally hingably coupled to the platform 130 and/or the cooler module 150, or may be uncoupled and otherwise situated over the platform 130. In this manner, the entire cover assembly 300 may be rotated about one or more hinges to access the platform 130 such that a container can be placed on, or removed from, the platform 130, or the cover assembly 300 may be entirely disengaged from the platform 130 such that a container can be placed on, or removed from, the platform 130. Once a container is placed onto the platform 130, the rocking assembly 100 may be closed for processing liquid of the container by disposing the cover assembly 300 over the platform 130 and the container may be rocked and/or chilled optionally following a workflow protocol.

In various embodiments, the platform 130 includes a cavity 350 or securing member 360 configured to secure the container on the platform and inhibit sliding of the container during operation of the rocking assembly 100.

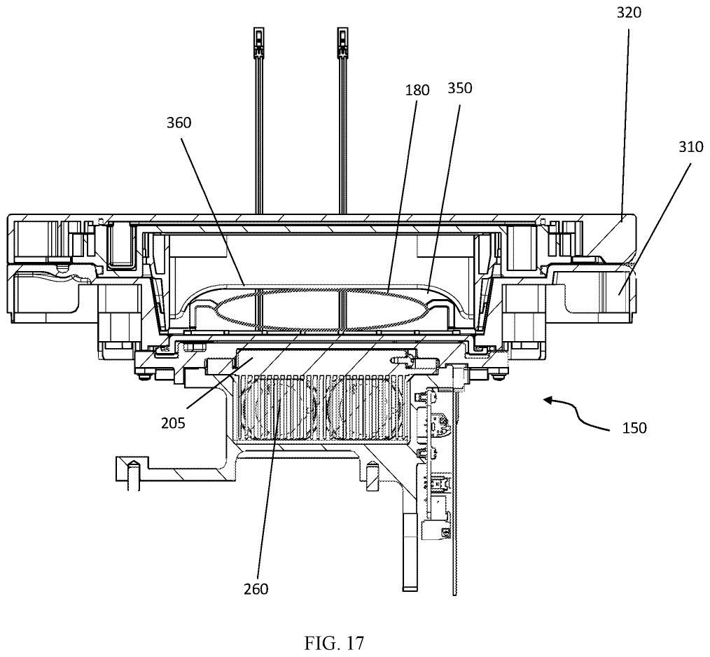

In various embodiments, the cover assembly 300 includes a cavity 350 and/or securing member 360 configured to secure the container on the platform 130 and inhibit sliding of the container during operation of the rocking assembly 100. In some embodiments, closing of the cover assembly 300 by disposing the cover assembly over the platform 130 forms a cavity 350 for securing the container on the platform. In some embodiments, closing of the cover assembly 300 by disposing the upper cover member 320 over the lower cover member 310 forms a cavity 350 to secure the container on the platform 130 during operation of the rocking assembly 100. For example, FIG. 17, is a cross sectional diagram showing a portion of the rocking assembly 100, in which the cover assembly 300 is closed with the upper cover member 320 being disposed over the lower cover assembly, and a container is secured within a cavity 350 such that the container is in contact with the platform 130.

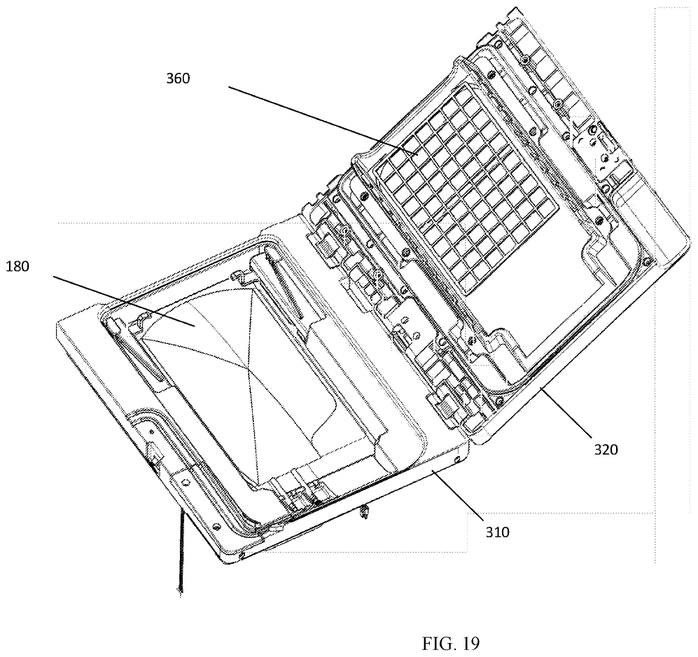

As discussed herein, in various embodiments, the rocking assembly 100 may include a securing member 360 configured to secure the container on the platform 130. In some embodiments, the securing member 360 may be formed unitary with, or otherwise attached to the cover assembly 300. For example, as illustrated in FIG. 17, the cover assembly 300 includes a cavity 350 for receiving the container 180 and a securing member 360 is attached to the cover assembly 300 and functionally engaged with the container when the cover assembly is closed. In some embodiments, the securing member 360 is a flexible mesh that is secured over the container by attaching the mesh directly to a portion of the cover assembly 300, the cooler module 150, and/or the platform 130. For example, FIG. 19 illustrates a flexible rubber mesh coupled to the upper cover member 320 of the cover assembly 300 which secures the container when the cover assembly is closed and disposed over the platform 130.

It will be appreciated that the securing member may have various shapes and dimensions and be formed from a variety of material types. For example, the securing member may include one or more fasteners, buckles, straps, ropes, belts, bands, strings, velcro, adhesives, or other type(s) of structure that engages with the container to secure the container on the platform 130. In some embodiments, the securing member is coupled to the cover assembly 300 and includes a resiliently flexible material that is configured to expand and/or contract as the outer shape or outer volume of the container increases or decreased as liquid is added or removed from the container, such as a flexible bag. By way of example, and in no way limiting, the securing member may include a resiliently flexible thread, band, strap, tube, shaft, mesh, fabric, sheet, foil, mat or the like. Suitable materials for inclusion in the securing member include, but are not limited to silicone, rubber, polymer, plastic, nitrile, neoprene, elastomer, elastic, urethane, vinyl and the like.

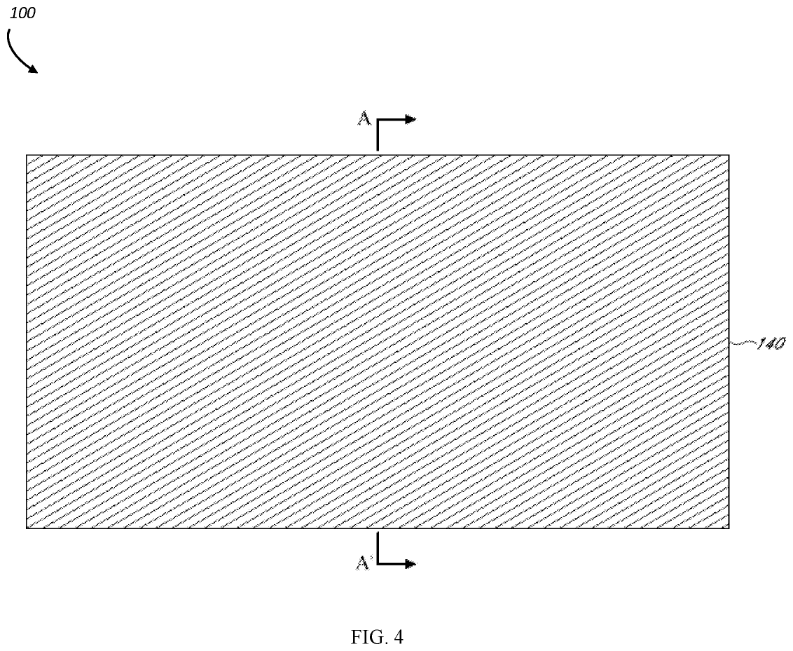

FIGS. 1-3 illustrate movement of the platform 130 in a rocking motion when the actuator 160 is actuated. The rocking motion facilitates mixing of the liquid contents of the container disposed on the platform 130. While the embodiment illustrated in FIGS. 1-3 is shown with the actuator and mount 120 being connected to the base unit 110 to allow rocking about a single transverse axis of the platform 130 (see FIG. 4), it will be appreciated that multiple degrees of motion may be achieved by a variety of combinations of additional mounts and/or actuators being in variable operable connection with the base unit 110. For example, the rocking assembly 100 may be configured such that the rocking motion of the platform 130 occurs about a single transverse axis of the platform (across a length, width or combination thereof) as shown in FIG. 4, or may occur about multiple transverse axes of the platform depending on the location and number of actuators.

In fact, the rocking assembly 100 may be configured such that rocking motion may be achieved about any transverse axis of the platform 130. For example, the platform 130 may be coupled to the base unit 110 by a single mount 120 coupled to an actuator that is configured to provide rocking movement to the platform about an axis disposed at any radial degree to a line parallel to the top surface of the platform. In one embodiment, this is achieved by a ball and socket, or shaft and sheath type connection in which the platform 130 is coupled to the base unit 110 via a mount 120 configured to receive the coupling connection of the platform. In such an arrangement, one or more actuators may be situated with respect to the base unit 110 to contact the platform 130 and provide force directly to the platform to cause rocking movement in any direction, or apply force directly to the coupling connection via the mount 120 to cause rocking movement in any direction.

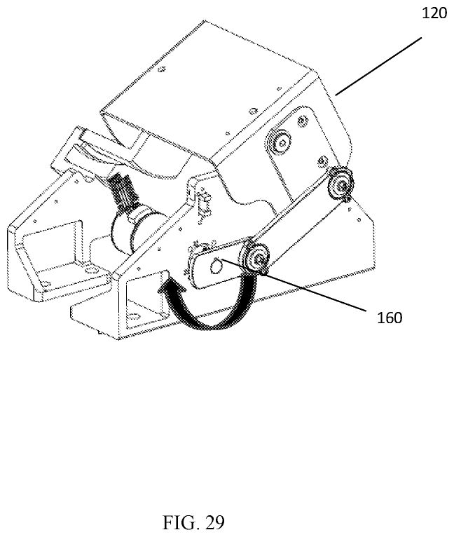

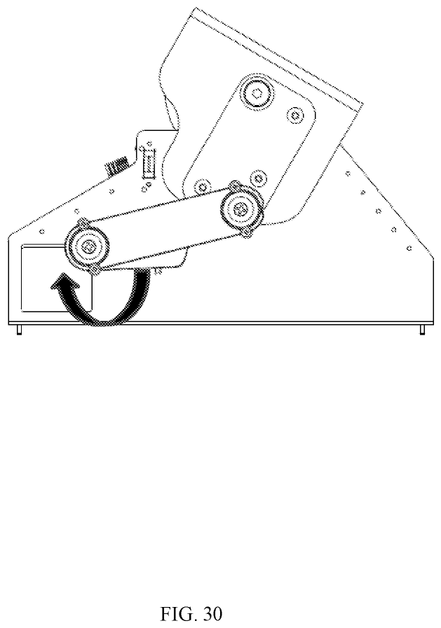

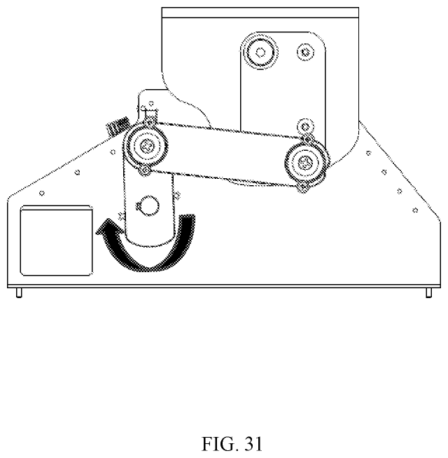

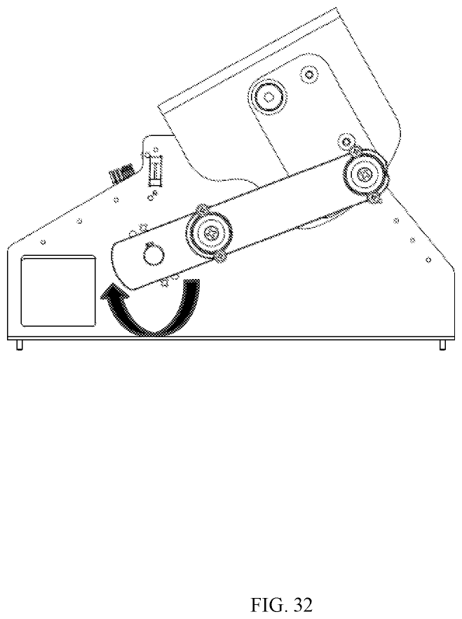

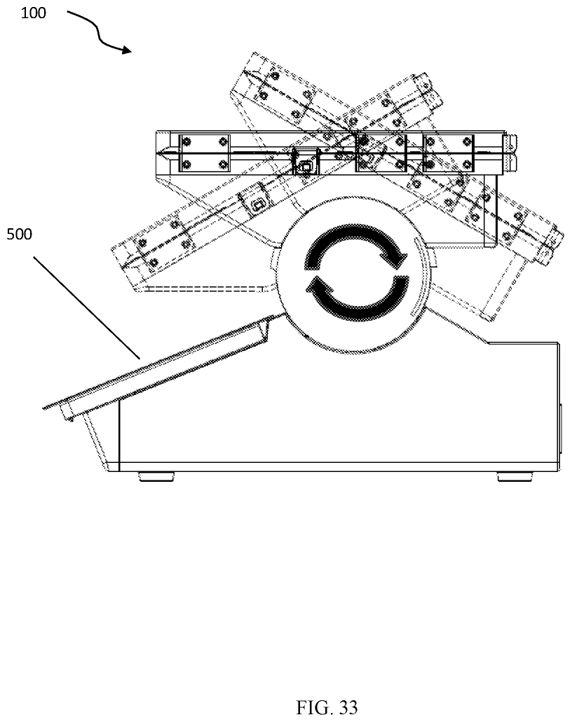

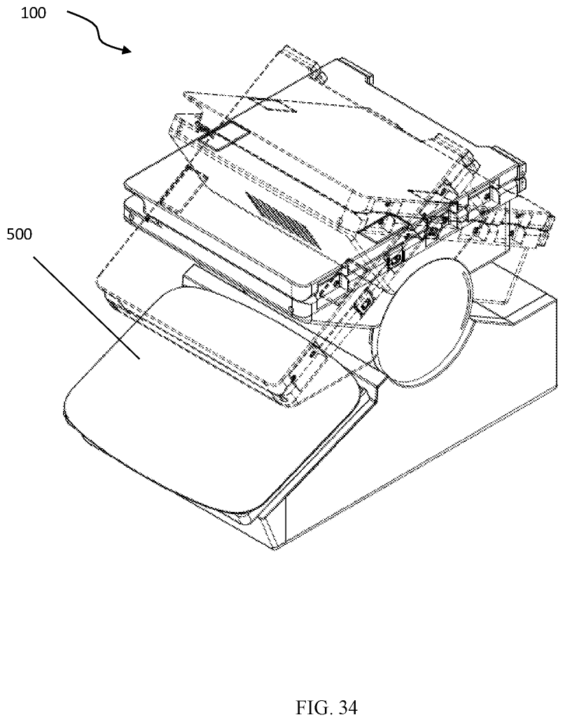

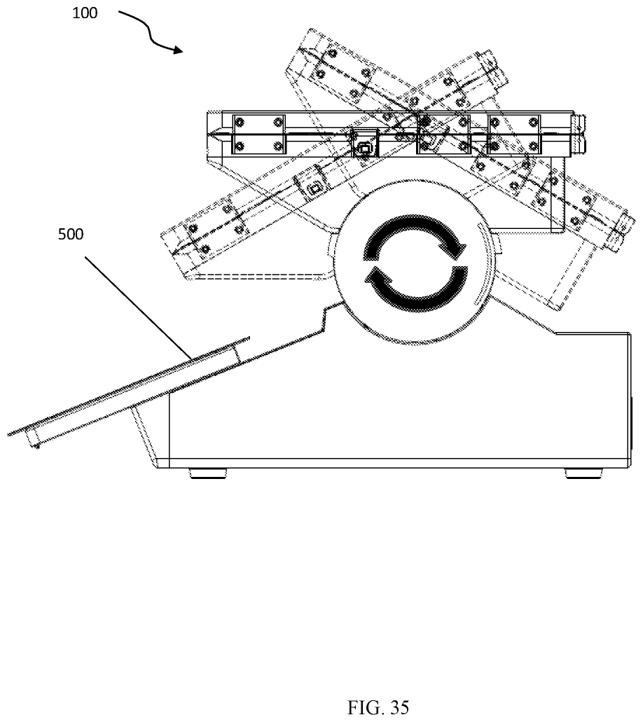

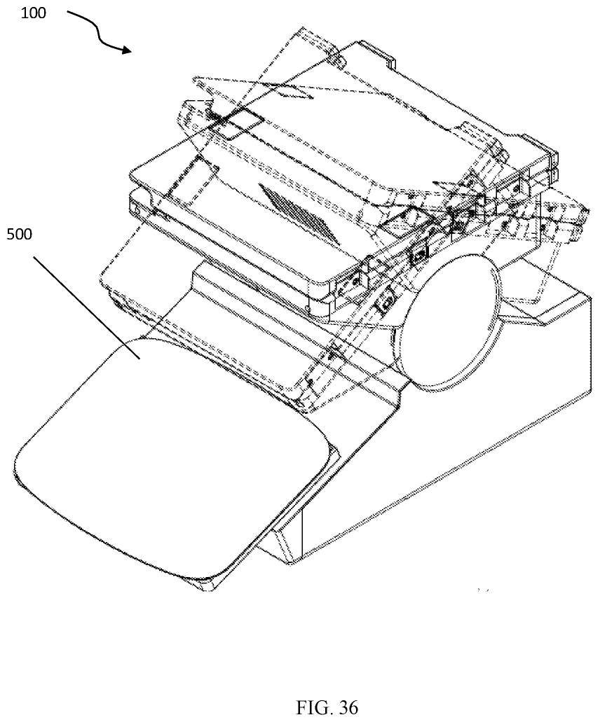

FIGS. 33-36, illustrate a rocking assembly 100 configured to generate rocking of the platform 130 such that tilting of the platform is along a single axis of the platform. For example, the actuator type shown in FIGS. 29-32 produces a rocking motion of the platform 130 in which one side of platform is tilted in a negative angle relative to the base unit 110 while an opposing side of the platform is tilted in a positive angle relative to the base unit 110. In various embodiments, the rocking assembly 100 is configured to continually cycle the angle of the platform 130 between about −80 to 80, −75 to 75, −70 to 70, −65 to 65, −60 to 60, −55 to 55, −50 to 50, −45 to 45, −40 to 40, −35 to 35, −30 to 30, −25 to 25, −20 to 20, −15 to 15, −10 to 10, or −5 to 5 degrees with respect to the horizontal plane of a horizontal support surface upon which the base unit 110 of the rocking assembly 100 is arranged.

In some embodiments, the rocking assembly 100 is configured to rock the platform 130 at a variable speed, e.g., cycles per minute (CPM) about a single transverse axis of the width or length of the platform. In some embodiments, the rocking assembly 100 is configured rock the platform 130 at a constant speed about a single transverse axis of the width or length of the platform. In various embodiments, the rocking assembly 100 is configured to rock the platform at a constant speed of about 5, 10, 15, 20, 25, 30, 35, 40 or 45 cpm.

In various embodiments, the rocking assembly 100 is operable to tilt the platform 130 about a single transverse axis of the width or length of the platform to an angle of between about 0-90, 0-80, 0-70, 0-60, 0-50, 0-40, 0-30, 0-20 and 0-10 degrees with respect to the base unit 110 of the rocking assembly 100. In various embodiments, the rocking assembly 100 is operable to tilt the platform 130 about a single transverse axis of the width or length of the platform to an angle of between about 0-90, 0-80, 0-70, 0-60, 0-50, 0-40, 0-30, 0-20 and 0-10 degrees with respect to the base unit 110 of the rocking assembly 100.

In some embodiments, the rocking assembly 100 is configured such that the platform 130 performs successive tilting cycles about a single transverse axis of the width or length of the platform to an angle of between about 0-90, 0-80, 0-70, 0-60, 0-50, 0-40, 0-30, 0-20 and 0-10 degrees with respect to the base unit 110 of the rocking assembly 100 at a constant rate of speed. In some embodiments, the rocking assembly 100 is configured such that the platform 130 performs successive tilting cycles about a single transverse axis of the width or length of the platform to an angle of between about 0-90, 0-80, 0-70, 0-60, 0-50, 0-40, 0-30, 0-20 and 0-10 degrees with respect to the base unit 110 of the rocking assembly 100 at a constant rate of speed of about 5, 10, 15, 20, 25, 30, 35, 40 or 45 cpm.

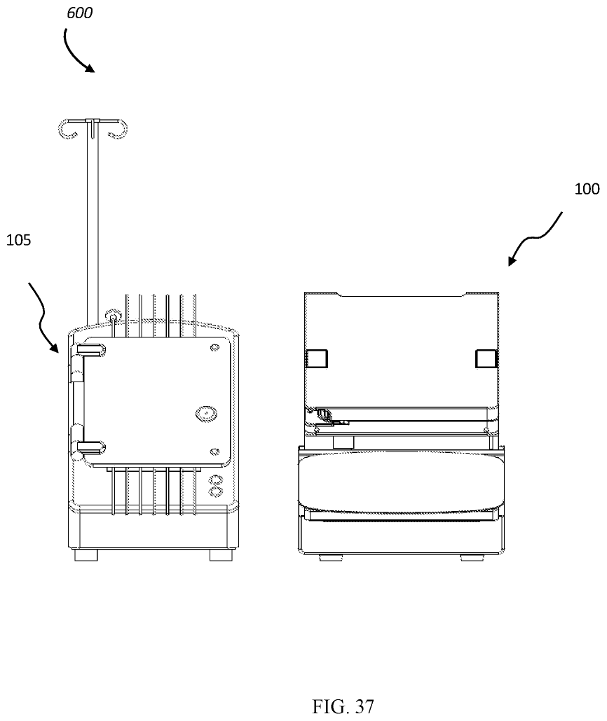

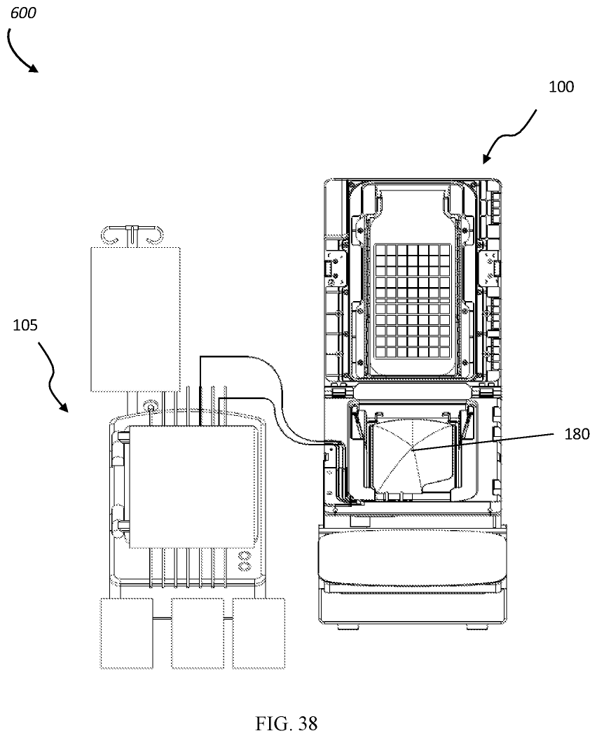

The disclosure also provides a cell processing system used for fill and finish processes in the manufacture of reagents and therapeutics, such as cell-based therapeutics. In embodiments, the cell processing system includes a rocking assembly 100 of the disclosure and a liquid dispensing system 105 as shown in FIGS. 37 and 38.

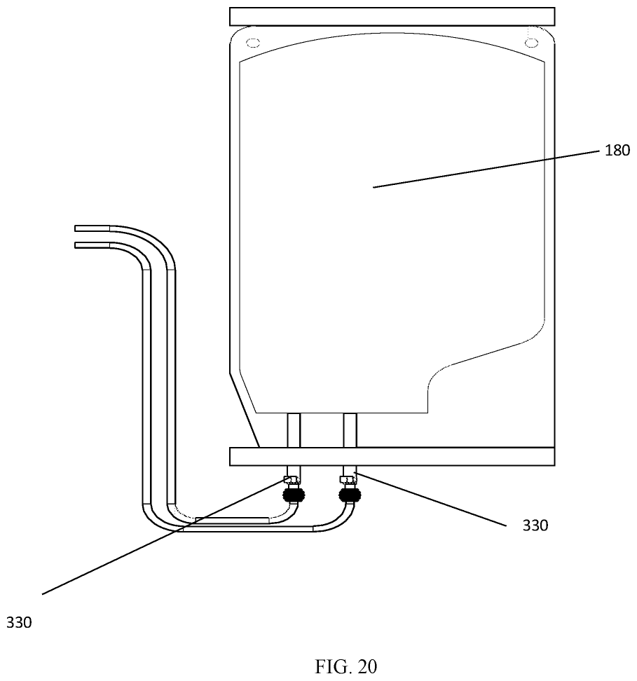

In various embodiments, the rocking assembly 100 and the liquid dispensing system 105 are in electronic communication so that operations of the separate assemblies can be aligned to ensure a minimal loss in cell viability throughout fill and finish processing. In some embodiments, the rocking assembly 100 and the liquid dispensing system 105 are fluidically coupled. For example, as illustrated in FIGS. 20 and 38, a container disposed on the platform 130 of the rocking assembly 100 includes one or more fluid conduits 330 that are fluidically coupled to the liquid dispensing system 105 and fluid flow of liquid through the fluid conduits is controlled via functionality of the liquid dispensing system 105 to perform a fill and finish operation as shown in FIG. 37. As such, liquid may be added or removed from the container disposed on the platform 130 of the rocking assembly 100 by operation of functionality of the liquid dispensing system 105. In some embodiments, a liquid, such as a reagent or cell containing liquid, contained in a container of the liquid dispensing system 105 is flowed into the container disposed on the platform 130 of the rocking assembly 100 via operation of the liquid dispensing system 105, the liquid of the container on the platform 130 is mixed and cooled and subsequently dispensed into one or more containers of the liquid dispensing system 105 via operation of the liquid dispensing system 105. In this manner, a liquid pharmaceutical may be mixed, chilled to prevent degradation of contents of the liquid, and dispensed into liquid pharmaceutical dosages to formulate and/or generate a cell or gene therapy product for example. Similarly, a liquid reagent or biomolecule containing liquid may be mixed, chilled to prevent degradation of contents of the liquid, and dispensed into liquid dosages to formulate and/or generate a containerized product.

It will be appreciated that any number of liquids of a variety of types may be added to the container by the liquid dispensing system 105 before mixing and cooling on the rocking assembly 100. For example, 1, 2, 3, 4, 5, 6, 7, 8, 9, 10 or more different types of liquids may be added to a container disposed on the platform 130 of the rocking assembly 100. It will also be appreciated that the container may be pre-filled and then loaded onto the platform 130 of the rocking assembly 100 and mixed and cooled.

As discussed herein, the rocking assembly 100 and the liquid dispensing system 105 may be communicatively configured in input/output communication. In some embodiments, the rocking assembly 100 includes at least one computer module 250 having at least one computer processor with functionality to control operation of the cooler module 150, the rocking motion of the platform 130 via the actuator, or a combination thereof, and the liquid dispensing system 105 includes at least one computer module 250 communicatively configured in input/output communication with the at least one computer module 250 of the rocking assembly 100 to perform a workflow protocol. In some embodiments, operation of the rocking assembly 100 is controlled by operational instructions received from the liquid dispensing system 105 to perform a workflow protocol. As such, in some embodiments, the liquid dispensing system 105 includes at least one computer module 250 communicatively configured in communication with the rocking assembly, in which the at least one computer module 250 has at least one computer processor with functionality to control operation of the cooler module 150, the rocking motion of the platform 130 via the actuator, or a combination thereof.

In various embodiments, the rocking assembly 100 includes functionality to log data generated in performing a workflow protocol and optionally transmit the data to the liquid dispensing system 105 and/or a remote computing device, such as a remote server. Illustrative examples of data generated in performing a workflow protocol that may be logged includes temperature monitoring data of aspects of the platform 130 (e.g., platform temperature) and/or container liquid, flow data of liquid added to and/or removed from a container, time stamp/event data, quality control data, operational data of the rocking assembly (e.g., rocking speed, time, platform angle and/or platform temperature), data associated with GMP and cGMP of a liquid pharmaceutical or reagent, and the like.

In some embodiments, the liquid dispensing system is a type disclosed in WO2023/272360, incorporated herein by reference in its entirety. In embodiments shown in WO2023/272360, the liquid dispensing system, also referred to as a liquid handling system, is configured for preparation of small volume liquid formulations and dispensing into output vessels. The system can be utilized for a variety of low volume liquid formulation preparation applications, with cell therapies being one example application.

In various embodiments, the rocking assembly 100 and/or cell processing system of the disclosure includes any combination of processor(s), storage, input/output system(s) (I/O system(s)), and communication system(s). In some embodiments, the processor(s) may include one or more sets of electronic circuitries that include any number of logic units, registers, and/or control units to facilitate the execution of computer-readable instructions (e.g., instructions that form a computer program). Such computer-readable instructions may be stored within storage. The storage may include physical system memory and may be volatile, non-volatile, or some combination thereof. Furthermore, storage may include local storage, remote storage (e.g., accessible via communication system(s) or otherwise), or some combination thereof.

The processor(s) may be configured to execute instructions stored within storage to cause the rocking assembly to perform certain actions and/or commands (e.g., rocking motion direction, speed, angle, or duration, chilling of the platform, user interface presentation, receiving user input, component detection, etc.). The actions may rely at least in part on data stored on storage in a volatile or non-volatile manner.

In some embodiments, the actions may rely at least in part on communication system(s) for receiving data from remote system(s), which may include, for example, computing devices, sensors, and/or others. The communications system(s) may include any combination of software or hardware components that are operable to facilitate communication between on-system components/devices and/or with off-system components/devices. For example, the communications system(s) may include ports, buses, or other physical connection apparatuses for communicating with other devices/components. Additionally, or alternatively, the communications system(s) may include systems/components operable to communicate wirelessly with external systems and/or devices through any suitable communication channel(s), such as, by way of non-limiting example, Bluetooth, ultra-wideband, WLAN, infrared communication, and/or others.

Furthermore, the rocking assembly 100 and/or cell processing system may include or be in communication with I/O system(s). I/O system(s) may include any type of input or output device such as, by way of non-limiting example, a display, a touch screen, a mouse, a keyboard or button interface, a controller, and/or others, without limitation. For instance, the rocking assembly 100 and/or cell processing system may include a user interface element implemented in the form of a graphical touch-screen user interface. The user interface element is configured to display information related to operation of the rocking assembly 100 and/or cell processing system 600 and/or receive user input for facilitating control.

In some embodiments, the rocking assembly 100 includes an I/O system having a touch screen 500 as illustrated in FIGS. 33-37. In some embodiments, the touch screen 500 is coupled to the base unit 110 below the platform 130. In some embodiments, the touch screen 500 is slidably engaged with the base unit 110 as illustrated in FIGS. 33-37. As shown in the Figures, the touch screen 500 is slidable from a first position in which an upper portion of the touch screen is disposed under the platform 130 and only a portion of the touch screen is accessible by a user to perform input/output operations, and a second position in which the touch screen 500 is slid downward and a portion of the touch screen 500 is extended from the base unit 110 such that the entire touch screen is visible to, and can be accessed by a user to perform input/output operations. In various embodiments, the touch screen 500 is moved between the first and second positions manually, or in an automated manner, for example, by using an automated actuator. In some embodiments, moving the touch screen 500 from the first position to the second position cause the rocking motion of the platform 130 to stop or pause, and moving the touch screen 500 from the second position to the first position causes the rocking motion of the platform 130 to start or resume. In various embodiments, this functionality may be achieved by one or more sensors and/or switches in functional engagement with the touch screen 500 and/or base unit 110.

In various embodiments, the assembly and/or system includes one or more machine learning modules. Such modules may be utilized to optimize parameters of one or more aspects of the assembly or system described herein, for example to generate and/or optimize protocols, data storage, event/alarm chronicling, batch control, functional operation between instruments and the like.

In certain aspects the present disclosure provides a system for liquid processing that includes a computing device comprising one or more processors, and a memory, wherein the memory stores instructions that, when executed by the one or more processors, cause the computing device to perform any of the methods as disclosed herein. For example, the memory can store one or more weights associated with one or more trained machine learning models including, for example, one or more trained neural networks, as disclosed herein. The term “weights” as used herein in reference to a neural network, refers to all parameter values and network structure definitions necessary to propagate input data through the neural network in order to obtain an output value.

The system embodiments disclosed herein may achieve improved performance relative to conventional approaches. As such, in embodiments, this invention utilizes a machine learning model, for example a neural network that, combined with an integrated, fast computational architecture, allows for operational improvement of bioprocessing instruments, individually or as a bioprocessing instrument set and/or system.

Various methods and systems of the embodiments disclosed herein may improve upon conventional approaches to achieve the technical advantages of higher throughput, more exact algorithms, and faster, more robust processing by making use of a machine learning model, for example a trained neural network that allows for real-time processing of data, and displaying of representations of bioprocessing data. Such technical advantages are not achievable by routine and conventional approaches, and all users of systems including such embodiments may benefit from these advantages, for example, by assisting the user in the performance of a technical task, such as real-time high-throughput bioprocessing, by means of a guided human-machine interaction process. The technical features of the embodiments disclosed herein are thus decidedly unconventional in the field of fill and finish instruments, as are the combinations of the features of the embodiments disclosed herein. The present disclosure thus introduces functionality that neither a conventional computing device, nor a human, could perform. As used herein, the term ‘weights,’ in reference to a neural network, refers to all parameter values and network structure definitions necessary to propagate input data through the neural network to obtain an output value.

The present disclosure also provides a method of processing a liquid, such as a cell containing liquid. In various embodiments, the method includes mixing and/or cooling a liquid of a container disposed on the rocking assembly 100. In some embodiments, the rocking assembly 100 is fluidically and/or electronically coupled to a liquid dispensing system 105 to form a cell processing system 600 as described herein. As such, in some embodiments, the method further includes formulating and/or dispensing the liquid mixed and/or cooled on the rocking assembly 100.

As discussed herein, liquid of a container that is processed by the rocking assembly 100 may be added to the container before the container is loaded onto the platform 130 of the rocking assembly 100 and processed to cool the liquid. Alternatively, the container may be loaded onto the platform 130 of the rocking assembly 100 and filled by the liquid dispensing system 105 which is fluidically coupled to the container on the platform. In some embodiments, liquid is added to the container before the container is loaded onto the platform 130 of the rocking assembly, processed to cool the liquid, and then the container is fluidically coupled to the liquid dispensing system 105 for dispensing of the liquid from the container using functionality of the liquid dispensing system 105. In some embodiments, the container is fluidically coupled to the liquid dispensing system 105 before or after being loaded onto the platform 130 of the rocking assembly 100, the container is filled by functionality of the liquid dispensing system 105 and then processed to cool the liquid. Subsequently the liquid is dispensed using functionality of the liquid dispensing system 105. In some embodiments, the container is fluidically coupled to the liquid dispensing system 105 before or after being loaded onto the platform 130 of the rocking assembly 100, the container is filled by functionality of the liquid dispensing system 105 and then processed to cool the liquid. Subsequently the container is fluidically uncoupled from the liquid dispensing system 105 before removing the container from the platform.

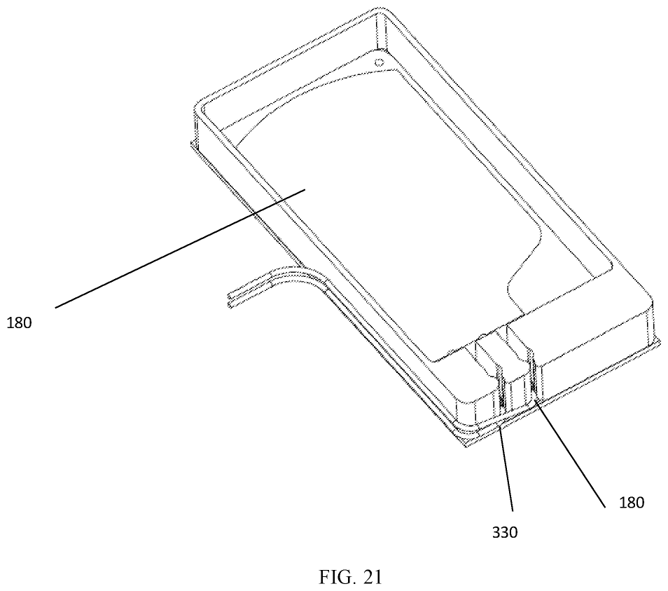

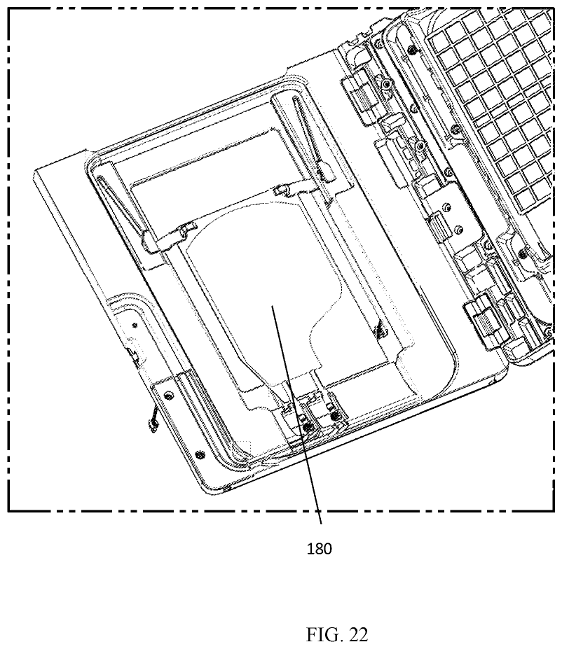

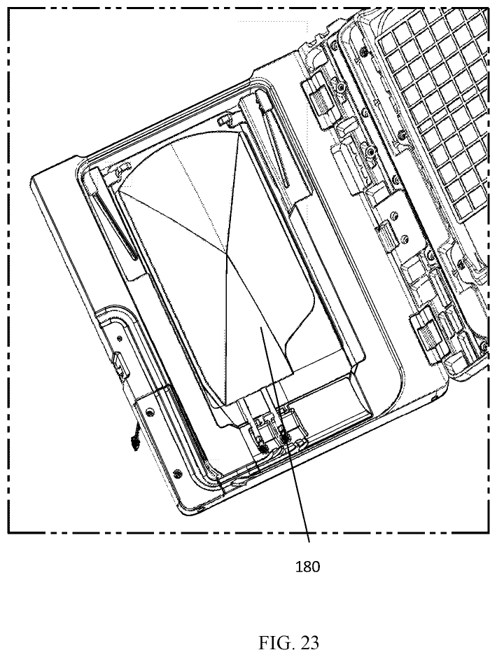

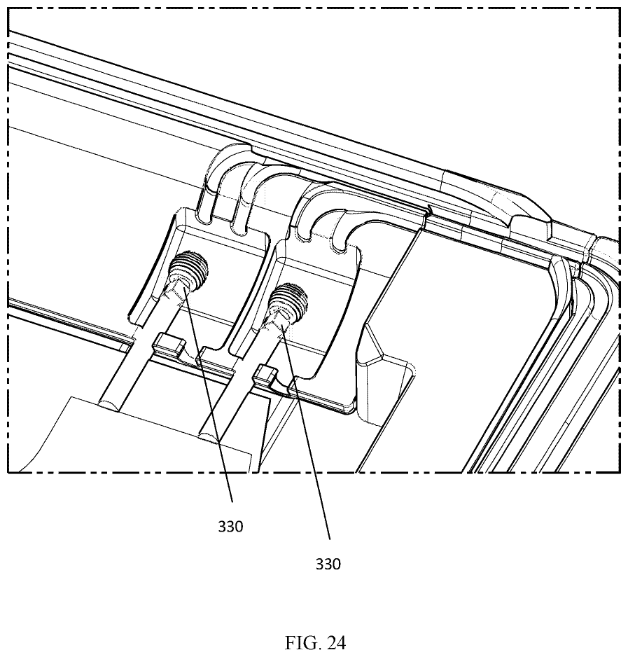

It will be appreciated that a container used to hold the liquid that is disposed on the platform 130 of the rocking assembly 100 can be a variety of shapes and dimensions so long as the bag is sized to be held by the platform. In various embodiments, the container may be composed of flexible material that allows the container to expand or contract as liquid is added or removed from the container. In some embodiments, the container is a flexible bag. An illustrate example of flexible bag type container for use with the rocking assembly 100 is shown in FIGS. 20-24. In various embodiments, the container, such as the flexible bag is sized to contain a volume of fluid of up to about 0.5, 1, 2, 3, 4 or 5 liters. In some embodiments, the container, such as the flexible bag is sized to contain a maximum volume of liquid of between about 0.1 to 1, 0.25 to 1, 0.5 to 1, 0.25 to 0.75, 0.75 to 1, or 0.75 to 1 liters.

While the container shown in FIGS. 20-24 includes 2 fluid conduits in fluid communication with the reservoir of the container, it will be appreciated that a container may include any number of fluid conduits, some of all of which may be fluidically coupled to the liquid dispensing system 105 or other vessel. As such, in various embodiments, the includes 1, 2, 3, 4, 5, 6, 7, 8, 9, 10 or more fluid conduits any number of which may be fluidically coupled or shunted to prevent fluid flow.

It will also be appreciated that any number of liquids of a variety of types may be added to the container by the liquid dispensing system 105 before mixing and cooling on the rocking assembly 100. For example, 1, 2, 3, 4, 5, 6, 7, 8, 9, 10 or more different types of liquids may be added to a container disposed on the platform 130 of the rocking assembly 100. Furthermore, as discussed herein, the container may be pre-filled and then loaded onto the platform 130 of the rocking assembly 100 to be processed (e.g., mixed and/or cooled).

In various embodiments, the liquid that is processed on the rocking assembly 100 includes components that are inhibited from degradation by cooling of the liquid, such as a biomolecule.

The term “biological molecule” or “biomolecule” is intended to generally refer to any organic or biochemical molecule that occurs in a biological system including a whole cell, a cellular component, a substrate, or any portions thereof.

As used herein, a “cellular component” is intended to include any component of a cell that may be at least partially isolated upon lysis of the cell. Cellular components include components that are recombinantly or synthetically produced which may be functionally and/or structurally altered to include synthetically (e.g., chemically synthesized) derived components. Cellular components may be organelles, such as nuclei, perinuclear compartments, nuclear membranes, mitochondria, chloroplasts, or cell membranes; polymers or molecular complexes, such as lipids, polysaccharides, proteins (membrane, trans-membrane, or cytosolic); nucleic acids, viral particles, or ribosomes; or other molecules, such as hormones, ions, cofactors, or drugs. In various embodiments, a liquid that is processed on the rocking assembly 100 includes a cell (e.g., a mammalian cell or a non-mammalian cell), cellular component, biomolecule, or other reagent (e.g., a reagent used in the development or manufacturing of cell and gene therapies). In some embodiments, the liquid includes a genetically modified cell or other gene therapy relevant cell, such as a stem cell, a pluripotent cell, a T cell, a B cell, an NK cell, a cytokine-secreting cell, a dendritic cell, a tumor cell, or a pathogen-infected cell. In some embodiments, the liquid includes a cell aggregate, such as a cell organoid, cell spheroid, microtumor, tissue and the like. In some embodiments, the liquid includes a nucleoside, nucleotide, amino acid, peptide, or any combination thereof. In some embodiments, the liquid includes an oligonucleotide, such as DNA or RNA. In some embodiments, the liquid includes a microorganism, a such as a virus, viral particle, fungi, bacteria, yeast, or any portion thereof. In some embodiments, the liquid includes a protein, such as a hormone, antibody, antibody fragment, cytokine and the like. In some embodiments, the liquid includes a reagent, such as a buffer, salt, carbohydrate, co-factor, cell culture media and the like. In some embodiments, the liquid includes a temperature sensitive organic or non-organic reagent. In some embodiments, the liquid includes a cryoprotectant reagent, such as dimethyl sulfoxide (DMSO), propylene glycol, ethylene glycol, glycerol, sugar, starch, polyvinyl pyrrolidone, polyethylene oxide, and the like.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that assemblies, systems, processes, and/or products according to certain embodiments of the present disclosure may include, incorporate, or otherwise include properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, processes, products, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

Exemplary Subject Matter of the Invention is represented by the following clauses:

Clause 1: A rocking assembly comprising: a base unit having a mount; a platform; a cooler module operably connected to the platform and the mount, the cooler module configured to cool the platform; and an actuator in operable connection with the cooler module, the actuator being configured to move the platform in a rocking motion relative to the base unit.

Clause 2: The rocking assembly of clause 1, wherein the rocking motion is about a single transverse axis of the platform.

Clause 3: The rocking assembly of clause 1, wherein the rocking motion is about 2 transverse axes of the platform.

Clause 4: The rocking assembly of clause 3, wherein the axes are in perpendicular alignment.

Clause 5: The rocking assembly of clause 1, wherein the rocking motion is omnidirectional about a transverse axis of the platform.

Clause 6: The rocking assembly of clause 1, wherein the actuator is configured move the platform in a rocking motion relative to the base unit, wherein the rocking motion along a single longitudinal axis of the platform and up to about 90, 80, 70, 60, 50, 40, 30, 20 or 10 degrees relative to the base unit.

Clause 7: The rocking assembly of any one of clauses 2-6, wherein the cooler module is operable to cool a top surface of the platform to a temperature of less than or equal to about 10, 9, 8, 7, 6, 5 or 4 °C.

Clause 8: The rocking assembly of clause 7, wherein the cooler module is operable to cool the top surface of the platform sufficient to cool a liquid disposed in a container disposed on the top surface to less than or equal to about 10, 9, 8, 7, 6, 5 or 4 °C.

Clause 9: The rocking assembly of clause 8, wherein the cooler module is operable to maintain the top surface of the platform, or the liquid at a temperature of less than or equal to about 10, 9, 8, 7, 6, 5 or 4 °C.

Clause 10: The rocking assembly of any one of the preceding clauses, wherein the cooler module comprises a thermo electric cooler.

Clause 11: The rocking assembly of clause 10, wherein the thermo electric cooler comprises: i) a top surface in operable engagement with the platform and being operable to cool the platform; and ii) a bottom surface operable to dissipate heat generated by operating the thermo electric cooler.

Clause 12: The rocking assembly of clause 11, wherein the cooler module comprises one or more temperature sensors operably coupled to the platform, the top surface of the thermo electric cooler, the bottom surface of the thermo electric cooler, or any combination thereof.

Clause 13: The rocking assembly of clause 12, wherein the temperature sensor is a resistance temperature detector or a thermistor.

Clause 14: The rocking assembly of any one of the preceding clauses, further comprising one or more sensors for monitoring the temperature of the platform or the liquid sample disposed on the platform.

Clause 15: The rocking assembly of any one of the preceding clauses, further comprising a securing member configured to secure the container to the platform.

Clause 16: The rocking assembly of clause 15, wherein the securing member is composed of a flexible material and configured to continuously secure the container to the platform as an outer dimension of the container expands or contracts.

Clause 17: The rocking assembly of any one of the preceding clauses, further comprising a cover assembly disposed over the platform.

Clause 18: The rocking assembly of clause 17, wherein the cover assembly comprises a cavity for receiving a container.

Clause 19: The rocking assembly of clause 18, wherein the container is secured in the cavity by a securing member.

Clause 20: The rocking assembly of clause 18 or 19, wherein the cover assembly is hingably secured to the cooler module or the platform, and wherein the container is secured in the cavity when the cover assembly is disposed over the platform.

Clause 21: The rocking assembly of clause 18 or 19, wherein the cover assembly further comprises a lower cover member and an upper cover member.

Clause 22: The rocking assembly of clause 21, wherein the lower cover member is hingably coupled to the upper cover member and the container is secured in the cavity when the upper cover member is disposed over the lower cover member.

Clause 23: The rocking assembly of clause 22, wherein the container is secured in the cavity by the securing member.

Clause 24: The rocking assembly of clause 23, wherein the securing member is composed of a flexible material and configured to continuously secure the container within the cavity as an outer dimension of the container expands or contracts.

Clause 25: The rocking assembly of any one of clauses 21-24, wherein the upper cover member and/or the lower cover member comprises grooves for receiving a fluid conduit fluidically coupled with a container received within the cavity.

Clause 26: The rocking assembly of any one of the preceding clauses, further comprising at least one computer module having at least one computer processor with functionality to control operation of the cooler module, the rocking motion of the platform via the actuator, or a combination thereof.

Clause 27: The rocking assembly of clause 26, wherein the at least one computer processor has functionality to control the rate of cooling of the cooler module, the speed of the rocking motion of the platform via the actuator, the angle of the platform during the rocking motion of the platform via the actuator, the direction of the rocking motion of the platform via the actuator, or any combination thereof.

Clause 28: The rocking assembly of any one of the preceding clauses, further comprising at least one computer module communicatively configured in input/output communication with a secondary computing device or remote server with functionality to control operation of the cooler module, the rocking motion of the platform via the actuator, or a combination thereof.

Clause 29: The rocking assembly of clause 28, wherein the secondary computing device or remote server comprises functionality to control the rate of cooling of the cooler module, the speed of the rocking motion of the platform via the actuator, the angle of the platform during the rocking motion of the platform via the actuator, the direction of the rocking motion of the platform via the actuator, or any combination thereof.

Clause 30: The rocking assembly of clause 28 or clause 29, wherein the secondary computing device is comprised in a liquid dispensing system.

Clause 31: The rocking assembly of any one of the preceding clauses, wherein the computing device is communicatively configured in communication with one or more bioprocessing instruments.

Clause 32: The rocking assembly of any one of the preceding clauses, further comprising a machine learning module operable to perform analysis of data using a machine learning process.

Clause 33: The rocking assembly of clause 32, wherein the machine learning process comprises a neural network.

Clause 34: The rocking assembly of clause 33, wherein the neural network is a feedforward network or a deep neural network.

Clause 35: A cell processing system comprising: a rocking assembly of any one of clauses 1-34; and a liquid dispensing system.

Clause 36: The cell processing system of clause 35, wherein the rocking assembly is communicatively configured in communication with the liquid handling system.

Clause 37: The cell processing system of clause 35, further comprising a container disposed on a platform of the rocking assembly, the container comprising a liquid dispensed by the liquid dispensing system.

Clause 38: The cell processing system of clause 37, wherein the container is filled with the liquid by the liquid dispensing system while the container is disposed on the platform of the rocking assembly.

Clause 39: The cell processing system of clause 35, wherein a container disposed on a platform of the rocking assembly is fluidically coupled with the liquid dispensing system.

Clause 40: The cell processing system of clause 39, wherein a liquid of the container disposed on the platform of the rocking assembly is dispensed on the liquid dispensing system using functionality of the liquid dispensing system to dispense the liquid.

Clause 41: The cell processing system of any one of the preceding clauses, wherein the rocking assembly comprises at least one computer module having at least one computer processor with functionality to control operation of the cooler module, the rocking motion of the platform via the actuator, or a combination thereof.

Clause 42: The cell processing system of clause 41, wherein the liquid dispensing system comprises at least one computer module communicatively configured in input/output communication with the at least one computer module of the rocking assembly.

Clause 43: The cell processing system of any one of the preceding clauses, wherein the liquid dispensing system comprises at least one computer module communicatively configured in communication with the rocking assembly, the at least one computer module having at least one computer processor with functionality to control operation of the cooler module, the rocking motion of the platform via the actuator, or a combination thereof.

Clause 44: The cell processing system of any one of the preceding clauses, wherein the rocking assembly or the liquid dispensing system comprises a machine learning module operable to perform analysis of data using a machine learning process, or the rocking assembly or the liquid dispensing system is communicatively configured in communication with the machine learning module.

Clause 45: The cell processing system of clause 44, wherein the machine learning process comprises a neural network.

Clause 46: The cell processing system of clause 45, wherein the neural network is a feedforward network or a deep neural network.

Clause 47: A method of processing a liquid, comprising: cooling a liquid contained by a container disposed on a platform of the rocking assembly of any one of clauses 1-34, or a platform of the rocking assembly of the cell processing system of any one of clauses 35-44.

Clause 48: The method of clause 47, further comprising rocking the container to mix the liquid.

Clause 49: The method of clause 47, wherein the container is disposed on a platform of the rocking assembly of the cell processing system.

Clause 50: The method of clause 49, wherein the container is fluidically coupled to the liquid dispensing system.

Clause 51: The method of clause 50, wherein the container is fluidically coupled to a fluid reservoir of the liquid dispensing system, or is fluidically coupled to a container engaged with the liquid dispensing system.

Clause 52: The method of clause 51, wherein the liquid is flowed from the fluid reservoir or the container engaged with the liquid dispensing system into, or out of, the container disposed on the platform, before or after cooling of the liquid.

Clause 53: The method of clause 52, wherein liquid cooled on the platform is dispensed by the liquid dispensing system into one or more containers to provide a liquid dosage form.

Clause 54: The method of clause 53, wherein the liquid dosage form comprises a genetically modified cell.

Clause 55: The method of clause 54, wherein the liquid dosage comprises a cryoprotectant reagent.

Clause 56: The method of clause 55, wherein the cryoprotectant is dimethyl sulfoxide (DMSO).

Clause 57: The method of any one of the preceding clauses, wherein the liquid is cooled to less than or equal to about 10, 9, 8, 7, 6, 5 or 4 °C via the platform.

Clause 58: The method of clause 47, wherein the liquid comprises a cell, or any portion thereof.

Clause 59: The method of clause 58, wherein the liquid comprises a cell, the cell being genetically modified.
Clause 60: The method of clause 58 or 59, wherein the cell is a cell or gene therapy relevant cell.

Clause 61: The rocking of clause 58 or 59, wherein the cell is selected from the group consisting of: a stem cell, a pluripotent cell, a T cell, a B cell, an NK cell, a cytokine-secreting cell, a dendritic cell, a tumor cell, or a pathogen-infected cell.

Clause 62: The method of clause 47, wherein the liquid comprises a cell aggregate.

Clause 63: The method of clause 64, wherein the cell aggregate is selected from the group consisting of cell organoids, cell spheroids, microtumors, and tissue or portion thereof.

Clause 64: The method of clause 47, wherein the liquid comprises a nucleoside, nucleotide, amino acid, peptide, or any combination thereof.

Clause 65: The method of clause 47, wherein the liquid comprises an oligonucleotide.

Clause 66: The method of clause 65, wherein the oligonucleotide comprises DNA or RNA.

Clause 67: The method of clause 47, wherein the liquid comprises a protein.

Clause 68: The method of clause 67, wherein the protein is an antibody or fragment thereof.

Clause 69: The method of clause 47, wherein the liquid comprises a temperature sensitive organic or non-organic reagent.

Clause 70: The method of clause 47, wherein the liquid comprises a virus, viral particle, fungi, bacteria, yeast, or any portion thereof.

Clause 71: The method of clause 47, wherein the liquid comprises a cryoprotectant reagent.

Clause 72: Use of the cell processing system of any one of clauses 35-45 to formulate, mix and/or cool a biomolecule containing liquid.

Clause 73: Use of the cell processing system of any one of clauses 35-45 to formulate, mix, cool and/or dispense a biomolecule containing liquid.

Clause 74: Use of the cell processing system of any one of clauses 35-45 to formulate and dispense a liquid dosage form.

Clause 75: The use of clause 74, wherein the liquid dosage form comprises a genetically modified cell.

Clause 76: Use of the rocking assembly of clauses 1-34 to cool and/or mix a biomolecule containing liquid.

Clause 77: Use of the rocking assembly of clauses 1-34 to cool and/or mix a liquid reagent.

Clause 78: Use of the cell processing system of any one of clauses 35-45 to formulate, mix, cool and/or dispense a liquid reagent.

What is claimed is:

1. A rocking assembly comprising:
a base unit having a mount;
a platform;
a cooler module operably connected to the platform and the mount, the cooler module configured to cool the platform; and
an actuator in operable connection with the cooler module, the actuator being configured to move the platform in a rocking motion relative to the base unit.

2. The rocking assembly of claim 1, wherein the rocking motion is about a single transverse axis of the platform.

3. The rocking assembly of claim 1, wherein the rocking motion is about 2 transverse axes of the platform.

4. The rocking assembly of claim 3, wherein the axes are in perpendicular alignment.

5. The rocking assembly of claim 1, wherein the rocking motion is omnidirectional about a transverse axis of the platform.

6. The rocking assembly of claim 1, wherein the actuator is configured move the platform in a rocking motion relative to the base unit, wherein the rocking motion along a single longitudinal axis of the platform and up to about 90, 80, 70, 60, 50, 40, 30, 20 or 10 degrees relative to the base unit.

7. The rocking assembly of any one of claims 2-6, wherein the cooler module is operable to cool a top surface of the platform to a temperature of less than or equal to about 10, 9, 8, 7, 6, 5 or 4 °C.

8. The rocking assembly of claim 7, wherein the cooler module is operable to cool the top surface of the platform sufficient to cool a liquid disposed in a container disposed on the top surface to less than or equal to about 10, 9, 8, 7, 6, 5 or 4 °C.

9. The rocking assembly of claim 8, wherein the cooler module is operable to maintain the top surface of the platform, or the liquid at a temperature of less than or equal to about 10, 9, 8, 7, 6, 5 or 4 °C.

10. The rocking assembly of any one of the preceding claims, wherein the cooler module comprises a thermo electric cooler.

11. The rocking assembly of claim 10, wherein the thermo electric cooler comprises: i) a top surface in operable engagement with the platform and being operable to cool the platform; and ii) a bottom surface operable to dissipate heat generated by operating the thermo electric cooler.

12. The rocking assembly of claim 11, wherein the cooler module comprises one or more temperature sensors operably coupled to the platform, the top surface of the thermo electric cooler, the bottom surface of the thermo electric cooler, or any combination thereof.

13. The rocking assembly of claim 12, wherein the temperature sensor is a resistance temperature detector or a thermistor.

14. The rocking assembly of any one of the preceding claims, further comprising one or more sensors for monitoring the temperature of the platform or the liquid sample disposed on the platform.

15. The rocking assembly of any one of the preceding claims, further comprising a securing member configured to secure the container to the platform.

16. The rocking assembly of claim 15, wherein the securing member is composed of a flexible material and configured to continuously secure the container to the platform as an outer dimension of the container expands or contracts.

17. The rocking assembly of any one of the preceding claims, further comprising a cover assembly disposed over the platform.

18. The rocking assembly of claim 17, wherein the cover assembly comprises a cavity for receiving a container.

19. The rocking assembly of claim 18, wherein the container is secured in the cavity by a securing member.

20. The rocking assembly of claim 18 or 19, wherein the cover assembly is hingably secured to the cooler module or the platform, and wherein the container is secured in the cavity when the cover assembly is disposed over the platform.

21. The rocking assembly of claim 18 or 19, wherein the cover assembly further comprises a lower cover member and an upper cover member.

22. The rocking assembly of claim 21, wherein the lower cover member is hingably coupled to the upper cover member and the container is secured in the cavity when the upper cover member is disposed over the lower cover member.

23. The rocking assembly of claim 22, wherein the container is secured in the cavity by the securing member.

24. The rocking assembly of claim 23, wherein the securing member is composed of a flexible material and configured to continuously secure the container within the cavity as an outer dimension of the container expands or contracts.

25. The rocking assembly of any one of claims 21-24, wherein the upper cover member and/or the lower cover member comprises grooves for receiving a fluid conduit fluidically coupled with a container received within the cavity.

26. The rocking assembly of any one of the preceding claims, further comprising at least one computer module having at least one computer processor with functionality to control operation of the cooler module, the rocking motion of the platform via the actuator, or a combination thereof.

27. The rocking assembly of claim 26, wherein the at least one computer processor has functionality to control the rate of cooling of the cooler module, the speed of the rocking motion of the platform via the actuator, the angle of the platform during the rocking motion of the platform via the actuator, the direction of the rocking motion of the platform via the actuator, or any combination thereof.

28. The rocking assembly of any one of the preceding claims, further comprising at least one computer module communicatively configured in input/output communication with a secondary computing device or remote server with functionality to control operation of the cooler module, the rocking motion of the platform via the actuator, or a combination thereof.

29. The rocking assembly of claim 28, wherein the secondary computing device or remote server comprises functionality to control the rate of cooling of the cooler module, the speed of the rocking motion of the platform via the actuator, the angle of the platform during the rocking motion of the platform via the actuator, the direction of the rocking motion of the platform via the actuator, or any combination thereof.

30. The rocking assembly of claim 28 or claim 29, wherein the secondary computing device is comprised in a liquid dispensing system.

31. The rocking assembly of any one of the preceding claims, wherein the computing device is communicatively configured in communication with one or more bioprocessing instruments.

32. The rocking assembly of any one of the preceding claims, further comprising a machine learning module operable to perform analysis of data using a machine learning process.

33. The rocking assembly of claim 32, wherein the machine learning process comprises a neural network.

34. The rocking assembly of claim 33, wherein the neural network is a feedforward network or a deep neural network.

35. A cell processing system comprising:
a rocking assembly of any one of claims 1-34; and
a liquid dispensing system.

36. The cell processing system of claim 35, wherein the rocking assembly is communicatively configured in communication with the liquid handling system.

37. The cell processing system of claim 35, further comprising a container disposed on a platform of the rocking assembly, the container comprising a liquid dispensed by the liquid dispensing system.

38. The cell processing system of claim 37, wherein the container is filled with the liquid by the liquid dispensing system while the container is disposed on the platform of the rocking assembly.

39. The cell processing system of claim 35, wherein a container disposed on a platform of the rocking assembly is fluidically coupled with the liquid dispensing system.

40. The cell processing system of claim 39, wherein a liquid of the container disposed on the platform of the rocking assembly is dispensed on the liquid dispensing system using functionality of the liquid dispensing system to dispense the liquid.

41. The cell processing system of any one of the preceding claims, wherein the rocking assembly comprises at least one computer module having at least one computer processor with functionality to control operation of the cooler module, the rocking motion of the platform via the actuator, or a combination thereof.

42. The cell processing system of claim 41, wherein the liquid dispensing system comprises at least one computer module communicatively configured in input/output communication with the at least one computer module of the rocking assembly.

43. The cell processing system of any one of the preceding claims, wherein the liquid dispensing system comprises at least one computer module communicatively configured in communication with the rocking assembly, the at least one computer module having at least one computer processor with functionality to control operation of the cooler module, the rocking motion of the platform via the actuator, or a combination thereof.

44. The cell processing system of any one of the preceding claims, wherein the rocking assembly or the liquid dispensing system comprises a machine learning module operable to perform analysis of data using a machine learning process, or the rocking assembly or the liquid dispensing system is communicatively configured in communication with the machine learning module.

45. The cell processing system of claim 44, wherein the machine learning process comprises a neural network.

46. The cell processing system of claim 45, wherein the neural network is a feedforward network or a deep neural network.

47. A method of processing a liquid, comprising:
cooling a liquid contained by a container disposed on a platform of the rocking assembly of any one of claims 1-34, or a platform of the rocking assembly of the cell processing system of any one of claims 35-44.

48. The method of claim 47, further comprising rocking the container to mix the liquid.

49. The method of claim 47, wherein the container is disposed on a platform of the rocking assembly of the cell processing system.

50. The method of claim 49, wherein the container is fluidically coupled to the liquid dispensing system.

51. The method of claim 50, wherein the container is fluidically coupled to a fluid reservoir of the liquid dispensing system, or is fluidically coupled to a container engaged with the liquid dispensing system.

52. The method of claim 51, wherein the liquid is flowed from the fluid reservoir or the container engaged with the liquid dispensing system into, or out of, the container disposed on the platform, before or after cooling of the liquid.

53. The method of claim 52, wherein liquid cooled on the platform is dispensed by the liquid dispensing system into one or more containers to provide a liquid dosage form.

54. The method of claim 53, wherein the liquid dosage form comprises a genetically modified cell.

55. The method of claim 54, wherein the liquid dosage comprises a cryoprotectant reagent.

56. The method of claim 55, wherein the cryoprotectant is dimethyl sulfoxide (DMSO).

57. The method of any one of the preceding claims, wherein the liquid is cooled to less than or equal to about 10, 9, 8, 7, 6, 5 or 4 °C via the platform.

58. The method of claim 47, wherein the liquid comprises a cell, or any portion thereof.

59. The method of claim 58, wherein the liquid comprises a cell, the cell being genetically modified.

60. The method of claim 58 or 59, wherein the cell is a cell or gene therapy relevant cell.

61. The rocking of claim 58 or 59, wherein the cell is selected from the group consisting of: a stem cell, a pluripotent cell, a T cell, a B cell, an NK cell, a cytokine-secreting cell, a dendritic cell, a tumor cell, or a pathogen-infected cell.

62. The method of claim 47, wherein the liquid comprises a cell aggregate.

63. The method of claim 64, wherein the cell aggregate is selected from the group consisting of cell organoids, cell spheroids, microtumors, and tissue or portion thereof.

64. The method of claim 47, wherein the liquid comprises a nucleoside, nucleotide, amino acid, peptide, or any combination thereof.

65. The method of claim 47, wherein the liquid comprises an oligonucleotide.

66. The method of claim 65, wherein the oligonucleotide comprises DNA or RNA.

67. The method of claim 47, wherein the liquid comprises a protein.

68. The method of claim 67, wherein the protein is an antibody or fragment thereof.

69. The method of claim 47, wherein the liquid comprises a temperature sensitive organic or non-organic reagent.

70. The method of claim 47, wherein the liquid comprises a virus, viral particle, fungi, bacteria, yeast, or any portion thereof.

71. The method of claim 47, wherein the liquid comprises a cryoprotectant reagent.

72. Use of the cell processing system of any one of claims 35-45 to formulate, mix and/or cool a biomolecule containing liquid.

73. Use of the cell processing system of any one of claims 35-45 to formulate, mix, cool and/or dispense a biomolecule containing liquid.

74. Use of the cell processing system of any one of claims 35-45 to formulate and dispense a liquid dosage form.

75. The use of claim 74, wherein the liquid dosage form comprises a genetically modified cell.

76. Use of the rocking assembly of claims 1-34 to cool and/or mix a biomolecule containing liquid.

77. Use of the rocking assembly of claims 1-34 to cool and/or mix a liquid reagent.

78. Use of the cell processing system of any one of claims 35-45 to formulate, mix, cool and/or dispense a liquid reagent.
